(19) United States
(12) Patent Application Publication
(10) Pub. No.: US 2009/0167505 A1
(43) Pub. Date: Jul. 2, 2009

(54) Operation processing apparatus

(75) Inventors: Tsuyoshi Ohashi, Hashima-shi (JP); Mika Matsushima, Inazawa-shi (JP); Kazunari Taki, Nagoya-shi (JP); Yasuhisa Ichikawa, Nagoya-shi (JP); Katsumi Toda, Toyota-shi (JP)

Correspondence Address: DAY PITNEY LLP, 7 TIMES SQUARE, NEW YORK, NY, 10036-7311, US

(73) Assignee: BROTHER KOGYO KABUSHIKI KAISHA

(21) Appl. No.: 12/380,126

(22) Filed: Feb. 24, 2009

Related U.S. Application Data
(63) Continuation-in-part of application No. PCT/JP07/66537, filed on Aug. 27, 2007.

(30) Foreign Application Priority Data
Aug. 25, 2006 (JP) 2006-229355
Sep. 29, 2006 (JP) 2006-268667

(51) Int. Cl. H04Q 5/22

(52) U.S. Cl. 340/10.51

(57) ABSTRACT

An operation processing apparatus that can utilize a RFID tag in an operation to an operation target with high convenience is provided. A search device has an antenna configured to carry out information transmission/receiving to a RFID circuit element provided with an IC circuit part storing information and an antenna connected to it and a communication control part, through which preference information of a user stored in the IC circuit part, respectively, or information corresponding to that is acquired, and on the basis of an acquired plurality of pieces of preference information of user, a desired logical expression for search is created, and a search signal for execution of a search using the logical expression for search is outputted.

### CROSS-REFERENCE TO RELATED APPLICATION

This is a CIP application PCT/JP2007/066537, filed Aug. 27, 2007, which was not published under PCT article 21(2) in English.

### BACKGROUND OF THE INVENTION

1. Field of the Invention

The present invention relates to an operation processing apparatus configured to execute predetermined operation processing to a target to be operated.

2. Description of the Related Art

It is widely practiced that, for example, when many pieces of information are to be managed, the many pieces of information are stored and held in a database and by carrying out a search operation by manual input of an operator using an appropriate search device, information is found out and acquired from the information in the database.

On the other hand, in article management, an information holding portion (barcode, RFID tag and the like) is provided at a product to be managed, and an information reading device that reads out the held information in a non-contact manner is already known. For example, if a RFID tag is provided as the information holding portion, it is called RFID (Radio Frequency Identification) system. In this system, a RFID circuit element provided at a label-like RFID tag is provided with an IC circuit part storing predetermined RFID tag information and an antenna connected to the IC circuit part for carrying out information transmission/receiving, for example, and even if the RFID tag is stained or arranged at a hidden position, an access (for reading/writing of information) is possible from the side of a reader/writer to the RFID tag information of the IC circuit part, and this system has been already put into practice in various fields.

As an example of a prior art using the RFID tag in the RFID system in a search operation to the database, an article management system described in JP, A, 2005-8346 is known. In this article management system (collection management system), correlation information (association information) between identification information (tag ID) of the RFID circuit element provided at each book and the article information (book information) is stored and held in a book storage database, and an operation terminal (processing computer) is connected so that the database can be searched. If a user wants to find an article (book), at a fixed operation terminal installed beside a book rack, the user searches information specifying a target article (name of the book, name of the author and the like) in the database while watching a display device (display monitor), and acquires identification information (tag ID) of the RFID circuit element corresponding to the article. After that, using the acquired tag ID and the like, the RFID circuit element of each book in the book rack is searched (scanned) by a reading device.

On the other hand, as another prior art using the RFID tag for operation of a target to be operated, there is known a system described in JP, A, 2006-91964, for example. In this prior art, an IC sheet on which a RFID circuit element (non-contact communication IC unit) is provided, respectively, on both faces of a sheet-like electromagnetic-wave shield material is disclosed, and a different function can be selectively used depending on which of the IC sheet the user places over the reader.

With the prior art described in JP, A, 2005-8346, an access to the database is made by a manual operation of an operator at a usual operation terminal such that an operator manually inputs information specifying a target article (name of the book, name of the author and the like) while watching the display (display monitor) and searches the database using this as a search tool. And identification information (tag ID) of the RFID circuit element corresponding to the article is acquired.

As mentioned above, this is a system in which the database and the RFID circuit element are combined, but in this system, identification information required for communication using the RFID circuit element is merely acquired from the database. In the search operation itself of the database, if a search operation using the RFID circuit element instead of manual input can be used, a desired search operation can be carried out casually with a simple method without a need of manually setting or inputting complicated search expressions, for example, and a burden on the operator (searcher) can be reduced, which is convenient, but such consideration has not been made, which is inconvenient.

With the prior art in JP, A, 2006-91964, by providing the RFID circuit element on both faces of the sheet-like electromagnetic-wave shield material, respectively, the IC sheet is constituted. Thus, it is necessary to write in the RFID tag information separately so as to create the RFID tag to the RFID circuit element for the front face and the RFID circuit element for the back face, which requires cumbersome operation and labor. Also, in view of the convenience at use of the IC sheet, if a function corresponding to the sheet surface is displayed on the back face and a function corresponding to the sheet back face is displayed on the front face, the cumbersome operation and labor are further required in creation of the respective RFID tags, which is inconvenient.

Either of the prior arts above using the RFID tag for an operation of the operation target has a disadvantage in convenience for users and is inconvenient.

### SUMMARY OF THE INVENTION

A first object of the present invention is to provide an operation processing apparatus that can use a RFID tag for an operation of an operation target with high convenience.

A second object of the present invention is to provide an operation processing apparatus that enables a database search operation using a RFID circuit element so as to improve convenience for searchers.

A third object of the present invention is to provide an operation processing apparatus that can create a RFID label for operation to operate an operation target simply in a lump sum.

### BRIEF DESCRIPTION OF THE DRAWING

FIG. 1 is an appearance perspective view illustrating an entire structure of a search apparatus according to a first embodiment of the present invention.

FIGS. 2A and 2B are a partially enlarged view illustrating an outline structure of a reading portion and a conceptual diagram conceptually illustrating its side face structure.

FIG. 3 is a system block diagram illustrating an outline of the search apparatus.

FIG. 4 is a block diagram illustrating an example of functional configuration of a RFID circuit element provided at a RFID tag.

FIG. 5 is a functional block diagram illustrating detailed configuration of a communication control part and an antenna.

FIG. 6 is an explanatory diagram for explaining an example of preference information in eating and drinking preference card.

FIG. 7 is an explanatory diagram on a front face and a back face of the eating and drinking preference card.

FIGS. 8A to 8B are explanatory diagrams for explaining how to make a search for the eating and drinking preference card from a state where the card is placed (how to be placed).

FIG. 9 is a diagram illustrating an example of a screen of a search result.

FIG. 10 is a diagram illustrating an example of a screen of a search result.

FIG. 11 is a functional block diagram illustrating functional configuration of a CPU and a database in a storage device.

FIG. 12 is a flowchart illustrating a control procedure executed by the CPU.

FIG. 13 is a flowchart illustrating a detailed procedure of Step S20 in FIG. 12.

FIG. 14 is a flowchart illustrating a detailed procedure of Step S35 in FIG. 12.

FIG. 15 is a diagram illustrating a variation using a matrix coil antenna.

FIG. 16 is a system configuration diagram illustrating an entire operation tag manufacturing system including an apparatus for producing a RFID label according to a second embodiment of the present invention.

FIG. 17 is a functional block diagram illustrating a detailed function of a PC and the apparatus for producing a RFID label constituting the operation tag manufacturing system.

FIG. 18 is a flowchart illustrating a control procedure executed by a control circuit of the PC when operation equipment and an operation command settings are inputted.

FIG. 19 is a flowchart illustrating a control procedure executed by the control circuit of the apparatus for producing a RFID label at production of the operation tag.

FIGS. 20A and 20B are a top view and a side view illustrating an example of an appearance of a tag label body.

FIG. 21 is a lateral sectional view by XXI-XXI′ section in FIG. 20A.

FIGS. 22A to 22C are diagrams illustrating a procedure that manufacture the operation tag using the RFID label constituting the tag label body produced by the apparatus for producing a RFID label.

FIGS. 23A and 23B are a top view and a bottom view illustrating an example of an entire outline structure of the operation tag.

FIG. 24 is a diagram illustrating an example of data configuration of a memory part of an IC circuit pat in the RFID circuit element in the RFID label constituting the tag label body produced by the apparatus for producing a RFID label.

FIG. 25 is a system block diagram illustrating entire configuration of a RFID tag operation system.

FIG. 26 is a functional block diagram illustrating detailed functions of the PC, reader, and projector constituting the RFID tag operation system.

FIG. 27 is a flowchart illustrating a control procedure executed by the control circuit of the PC when the RFID tag information of the operation tag is read out.

FIG. 28 is a flowchart illustrating a control procedure executed by the control circuit of the PC in a variation when the fact that tags constitute a single set is printed on a margin portion.

FIG. 29 is a flowchart illustrating a control procedure executed by the control circuit of the apparatus for producing a RFID label in a variation when the fact that tags constitute a single set is printed on a margin portion.

FIGS. 30A and 30B are a top view illustrating an example of an appearance of a tag label body in a variation when the fact that the tags constitute a single set is printed on the margin portion and its side view.

FIGS. 31A and 31B are a top view illustrating an example of an appearance of a tag label body in a variation when an operation tag having three or more RFID labels is produced and a diagram illustrating contents of the operation command stored in each RFID circuit element constituting the tag label body.

FIG. 32 is a perspective view illustrating an example of an entire outline structure of the operation tag produced by attaching the RFID label to a base material in the variation when the operation tag having three or more RFID labels is produced.

FIG. 33 is a flowchart illustrating a control procedure executed by the control circuit of the PC in a variation when the operation target is limited.

FIG. 34 is a flowchart illustrating a control procedure executed by the control circuit of the apparatus for producing a RFID label at production of the operation tag in the variation when the operation target is limited.

FIG. 35 is a diagram illustrating an example of data configuration of the memory part of the IC circuit part in the RFID circuit element in the RFID label constituting the produced tag label body in the variation in which the operation target is limited.

FIG. 36 is a system block diagram illustrating an entire RFID tag operation system including a reader in the variation in which the operation target is limited.

FIG. 37 is a flowchart illustrating a control procedure executed by the control circuit of the PC when the RFID tag information of the operation tag is read out in the variation in which the operation target is limited.

FIG. 38 is a diagram illustrating an example of data configuration of the memory part of the IC circuit part of the RFID circuit element of the RFID label in a variation in which a predetermined time is waited till command execution.

FIG. 39 is a flowchart illustrating a control procedure executed by the control circuit of the PC when the RFID tag information of the operation tag is read out in the variation in which a predetermined time is waited till command execution.

### DETAILED DESCRIPTION OF THE PREFERRED EMBODIMENTS

Embodiments of the present invention will be described below referring to the attached drawings.

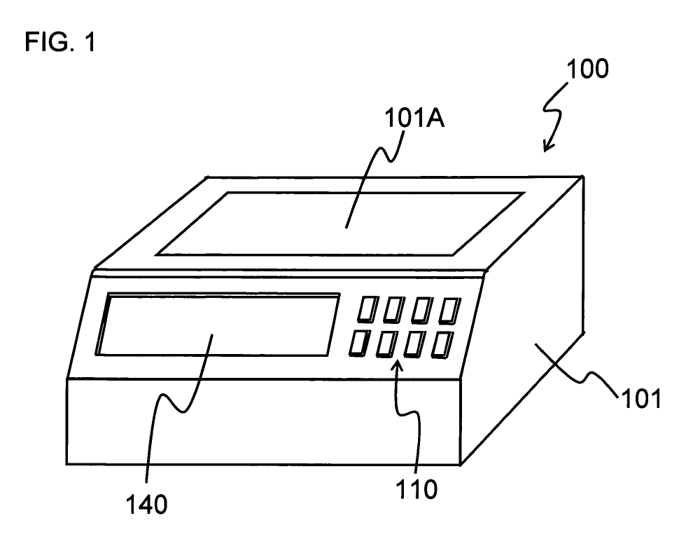

A first embodiment of the present invention will be described referring to FIGS. 1 to 15. The present embodiment is an embodiment as an example of search by an operator (searcher) when an optimal restaurant is to be searched according to a preference relating to a plurality of types/items of food and drink (hereinafter simply referred to as eating and drinking items).

FIG. 1 is an appearance perspective view illustrating an entire structure of a search apparatus 100 (operation processing apparatus) of this embodiment.

In FIG. 1, the search apparatus 100 of this embodiment is installed at locations such as station, shopping mall, public facilities, guest attracting facilities and the like, for example, where the general public gather, and if a user is to search a restaurant to take a meal, a desired search is carried out in relation to a preference of eating and drinking with a simple method.

The search apparatus 100 has a housing 101 provided with a reading portion 101A configured to read out information such as a plurality of cards (tag medium, hereinafter simply referred to as food preference cards A, B) corresponding to preferences of the above food items (like or dislike, hereinafter referred to as eating and drinking preference as appropriate), respectively, an operation portion 110 located on the front side of the housing 101 and provided with an appropriate key, button, switch, pad and the like (not shown) for giving various operation instructions such as “various search” and the like, which will be described later, and a display portion 140 configured to make a predetermined display corresponding to an operation of the operation portion 110 and the like.

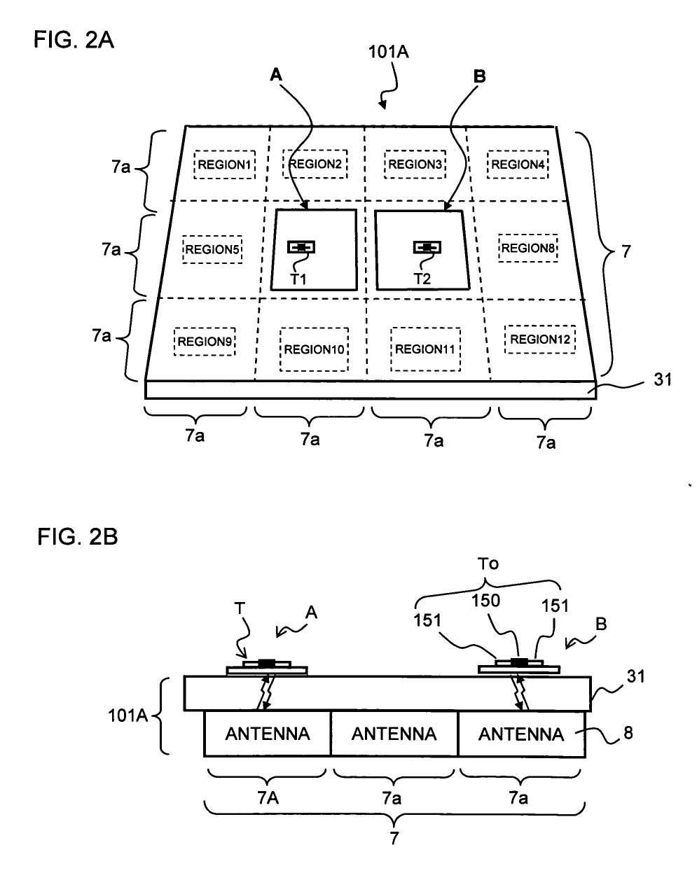

FIG. 2A is a partially enlarged view illustrating an outline structure of the reading portion 101A when eating and drinking preference cards A, B placed on the reading portion 101A of the search apparatus 100 are read out and FIG. 2B is a conceptual diagram conceptually illustrating its side-face structure.

In FIGS. 2A and 2B, the reading portion 101A is a mounting base formed in a single rectangular flat-plate shape in general and has a flat-plate shaped tray board 31 made of a material transmitting an electric wave and a plurality of (12 in this example) antennas 8 provided below the tray board 31, and a tag mounted region 7 on which the eating and drinking preference cards A, B are mounted is formed by the tray board 31, for example, and the antennas.

Each antenna 8 is constituted by a loop coil, for example, and in this example, they are arranged in plural (arrangement of 3 rows and 4 columns, totaling in 12 pieces in this example) in a matrix state in this example. The tag mounted region 7 corresponds to the 12 antennas 8 arranged in the matrix state and as shown by a broken line in FIG. 2A, it is divided into a plurality of tag detection regions 7a (communication regions. 12 regions of region 1 to region 12 in this example).

The eating and drinking preference cards A, B are provided with a RFID tag T, respectively. The RFID tag T is provided with a RFID circuit element To constituted by an IC circuit part 150 storing various information including at least a tag ID as identification information (other than the tag ID information, preference information and the like) and an antenna 151 connected to that. And each antenna 8 is configured in each corresponding tag detection region 7a so that information can be transmitted/received via radio communication with the RFID circuit element To provided at the eating and drinking preference cards A, B to be read out (=affixed, for example, however, it may be attached/packaged and the like. In short, it is only necessary that the circuit element is handled in relation).

Preferably, it is configured that the detection regions are clearly divided by setting the size of the antenna 8 smaller than the detection region 7a or reducing a communication output, for example, so that radio waves do not interfere between the adjacent antennas 8.

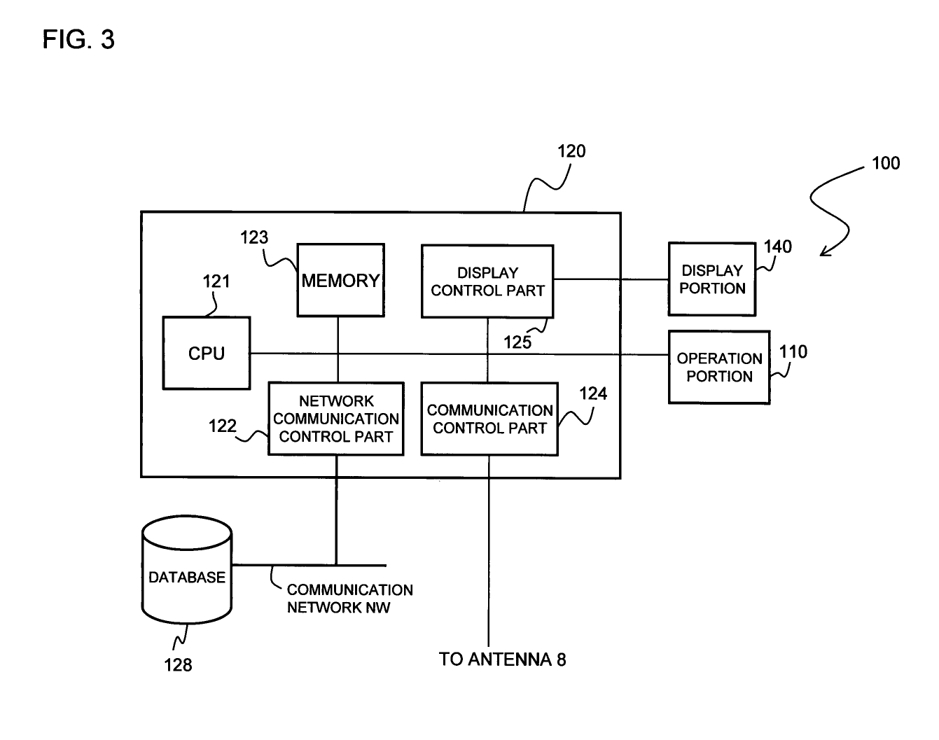

FIG. 3 is a system block diagram illustrating a functional constitution of the search apparatus 100 of this embodiment. In FIG. 3, the search apparatus 100 is provided with a control part 120, the display portion 140, and the operation portion 110.

The control part 120 is connected to a storage device 128 provided with a database in which various information relating to foods, beverages and the like are stored and held, capable of transmission/receiving of an information signal through a communication network NW constituted by a LAN, the Internet and the like (wired or wireless). That is, the control part 120 is provided with a CPU (central processing unit) 121, a network communication control part 122 configured to carry out control of signal transmission/receiving through the network NW, a memory 123 made of RAM and ROM, for example, a communication control part 124 configured to carry out communication control with the RFID circuit element To through the antenna 8, and a display control part 125 configured to control display of the display portion 140.

The storage device 128 provided with a database is constituted by a large-capacity storage device such as a hard-disk device, but if a required information amount is small and a memory capacity may be small, the device may be provided inside the control part 120 using a known non-volatile memory and the like (various information stored in the database 128 will be also described in detail later).

The CPU 121 carries out signal processing according to a program stored in advance in the ROM while using a temporary storage function of the RAM and thereby various execution command inputs are received from the operation portion 110, detection processing of the tag ID of the RFID tag T is carried out via radio communication through the antenna 8, corresponding preference information is acquired from the database 128 through the communication network NW based on the detection result, predetermined logical calculation processing is carried out, and a processing result is displayed on the display portion 140.

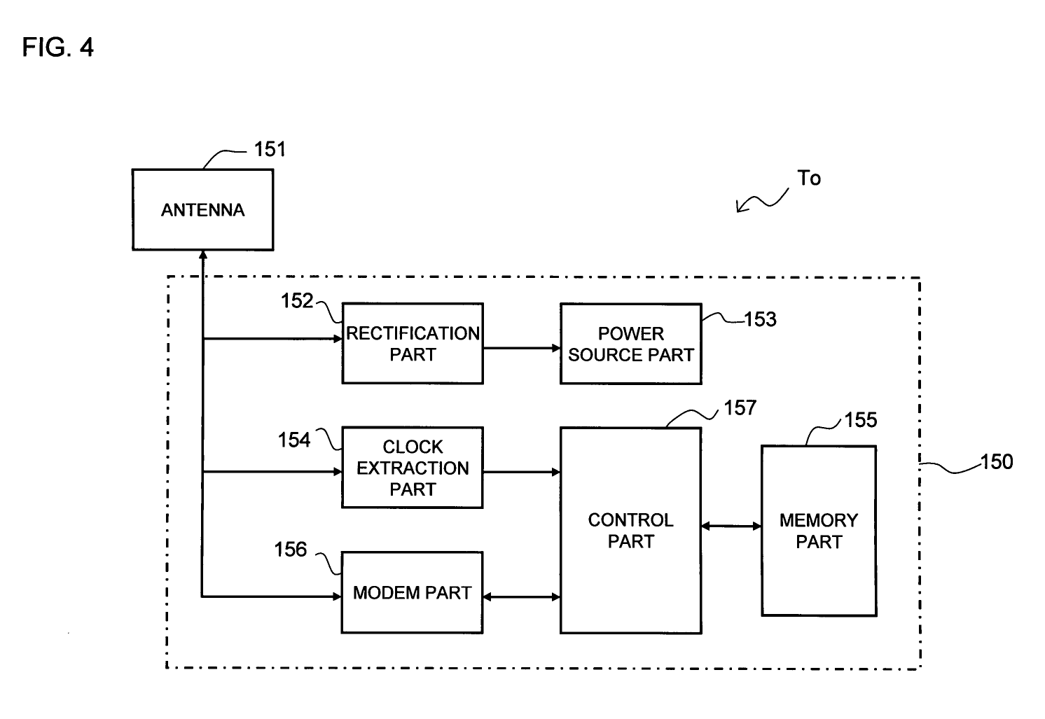

FIG. 4 is a block diagram illustrating an example of functional configuration of the RFID circuit element To provided at the eating and drinking preference cards A, B to be read out (scanned) of the search apparatus 100.

In FIG. 4, the RFID circuit element To has an antenna 151 (tag antenna) that carries out signal transmission/receiving in a non-contact manner using a predetermined frequency (short wave band (13.56 MHz and the like), UHF band, microwave band, for example) with the antenna 8 of the search apparatus 100 and the IC circuit part 150 connected to the antenna 151. If the predetermined frequency is a short wave band, a loop coil can be used suitable for the antenna 151 or a bent dipole antenna or a flat patch antenna for the UHF band.

The IC circuit part 150 comprises a rectification part 152 that rectifies a carrier wave received by the antenna 151, a power source part 153 that accumulates energy of the carrier wave rectified by the rectification part 152 so as to make it a driving power supply of the IC circuit part, a clock extraction part 154 that extracts a clock signal from the carrier wave received by the antenna 151 so as to supply it to a control part 157 (which will be described later), a memory part 155 which functions as an information storage portion that can store a predetermined information signal, a modem part 156 connected to the antenna 151, and the control part 157 that controls operation of the RFID circuit element To through the rectification part 152, the clock extraction part 154, the modem part 156 and the like.

The modem part 156 demodulates a communication signal from an antenna 130 of the product information management apparatus 100 received by the antenna 151 and modulates the carrier wave received at the antenna 151 based on a response signal from the control part 157 and re-transmits it as a reflective wave from the antenna 151.

The control part 157 interprets a received signal demodulated by the modem part 156, generates a reply signal based on the information signal stored in the memory part 155, and executes basic control such as control of reply by the modem part 156.

The clock extraction part 154 extracts a clock component from a received signal and extracts a clock to the control part 157 and supplies a clock corresponding to a speed of the clock component of the received signal to the control part 157.

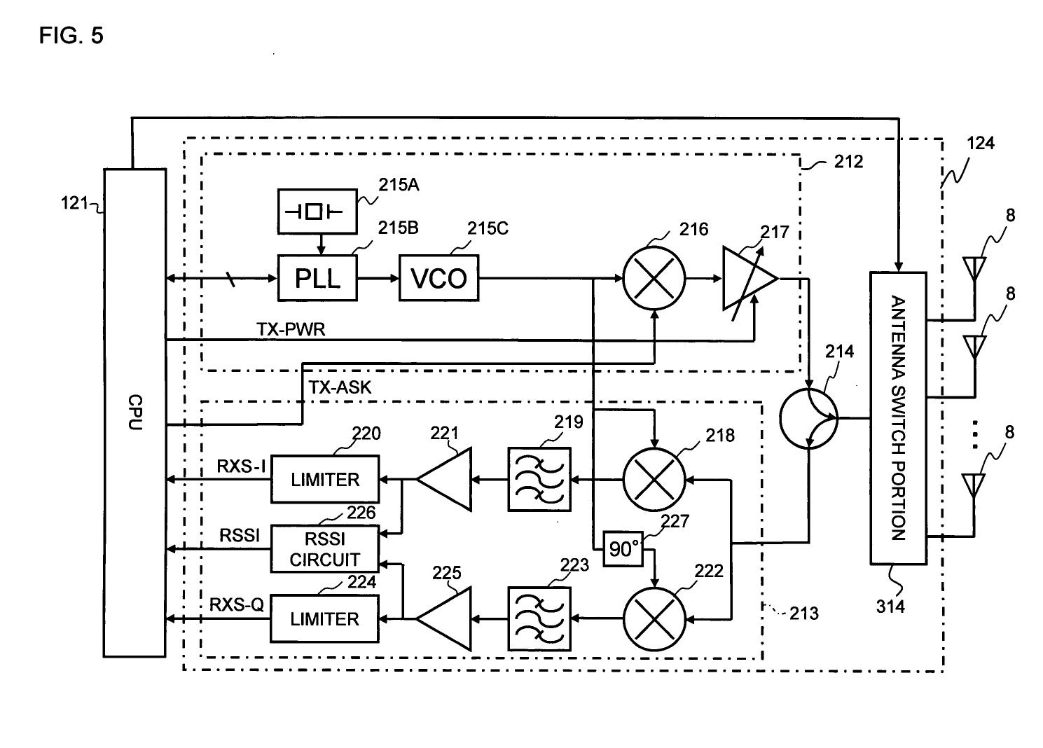

FIG. 5 is a functional block diagram illustrating detailed configuration of the communication control part 124 and the antenna 8.

The communication control part 124 makes an access to information (RFID tag information including tag ID) of the IC circuit part 150 of the RFID circuit element To through the antenna 8 and the CPU 121 of the control part 120 includes a function to process a signal read out of the IC circuit part 150 of the RFID circuit element To so as to read out information and to create access information to make an access to the IC circuit part 150 of the RFID circuit element To and controls the entire operation of the control part 120.

The communication control part 124 is configured by a transmission portion 212 that transmits a signal to the RFID circuit element To through the antenna 8, a receiving portion 213 to which a reflected wave from the RFID circuit element To received by the antenna 8 is inputted, a transmit-receive splitter 214, and an antenna switch portion 314 (switching control device).

The antenna switch portion 314 is a switch circuit using a known high-frequency FET or diode, for example, and connects any one of a plurality of antennas 8 to the transmit-receive splitter 214 according to a selection signal from the CPU 121. At this time, the CPU 121 stores the selection signal and the received signal in association so that which tag ID is detected by the antenna 8 at which location can be grasped.

The transmission portion 212 includes a crystal oscillator 215A configured to generate a carrier wave for accessing (for reading or writing) the RFID tag information stored in the IC circuit part 150 of the RFID circuit element To according to a control signal from the CPU 121, a PLL (Phase Locked Loop) 215B and a VCO (Voltage Controlled Oscillator) 215C that generate a signal with a predetermined frequency by control of the CPU 121, a transmission multiplying circuit 216 (however, it may be replaced by an amplitude factor variable amplifier or the like in the case of “TX_ASK” signal) that modulates (in this case, amplitude modulation based on the “TX_ASK” signal supplied from the CPU 121) the carrier wave generated by the carrier wave generating portion based on a signal supplied from the CPU 121, and a variable transmission amplifier 217 that amplifies the modulated waves modulated by the transmission multiplying circuit 216 (with an amplification factor determined according to a “TX_PWR” signal from the CPU 121 in this example. The carrier wave generated as above uses a frequency of short wave band (13.56 MHz and the like), UHF band or microwave band, for example, and the output from the transmission amplifier 217 is transmitted to the antenna 8 through the transmit-receive splitter 214 via the antenna switch circuit 314 and is supplied to the IC circuit part 150 of the RFID circuit element To. The RFID tag information is not limited to a signal modulated as above but may be a mere carrier wave depending on the case.

The receiving portion 213 includes a receiving signal first multiplying circuit 218 that multiplies and demodulates the reflected wave received from the RFID circuit element To through the antenna 8 by the carrier wave generated as described above, a first bandpass filter 219 that extracts only the signals within the necessary band range from the output of the receiving signal first multiplying circuit 218, a receiving signal first amplifier 221 that amplifies the output from the first bandpass filter 219, a first limiter 220 that further amplifies the output of the receiving signal first amplifier 221 and converts it to a digital signal, a receiving signal second multiplying circuit 222 that multiplies the reflected wave received from the RFID circuit element To at the antenna 130 by the carrier wave that is delayed by a phase shifter 227 by 90° after having been generated as described above, a second bandpass filter 223 that extracts only the signals within the necessary band range from the output of the receiving signal second multiplying circuit 222, and a receiving signal second amplifier 225 that amplifies the output of the second bandpass filter 223, and a second limiter 224 that further amplifies the output of the receiving signal second amplifier 225 and converts it to a digital signal. A signal “RXS-I” outputted from the first limiter 220 and a signal “RXS-Q” outputted from the second limiter 224 are inputted to the CPU 121 for processing.

Also, the outputs from the receiving signal first amplifier 221 and the receiving signal second amplifier 225 are inputted to an RSSI (Received Signal Strength Indicator) circuit 226 as an intensity detection device and a signal “RSSI” indicating the intensity of these signals is inputted to the CPU 121. As mentioned above, the communication control part 124 performs demodulation of the reflected wave from the RFID circuit element To by I-Q quadrature demodulation.

Here, at the search apparatus 100, as mentioned above, radio communication is made through the antenna 8 with the RFID circuit element To provided at each of the eating and drinking cards A, B, so as to acquire corresponding preference information stored in each RFID circuit element To. An essential part of the present embodiment is that a user forms a desired logical expression for search by using the preference information of the eating and drinking items indicated by the eating and drinking preference cards A, B as above as a search tool, by which an optimal restaurant matching his/her own preference information is searched (narrowed down). The detailed contents will be described below in order.

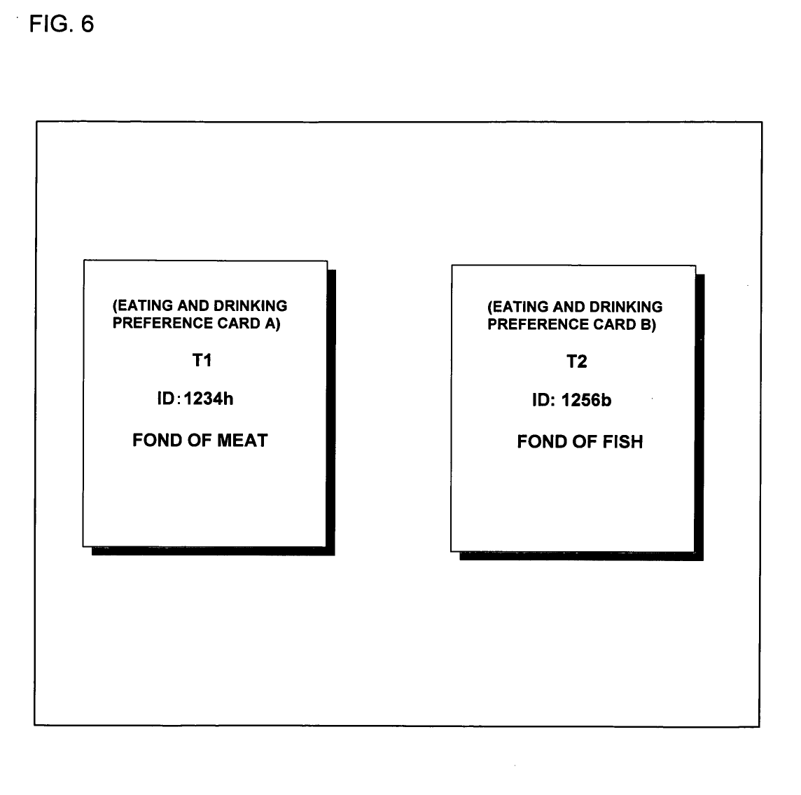

FIG. 6 is a conceptual explanatory diagram for explaining an example of the preference information in the eating and drinking preference card. In FIG. 6, in the RFID circuit elements To of the RFID tags T1, T2 built in the eating and drinking preference cards A, B, tag ID as identification information (displayed in hexadecimal number in the figure) and eating and drinking preference information (favorable or unfavorable eating and drinking items, types and the like in this example) are stored in a form of information associated in advance. The preference information is prepared in advance according to typical eating and drinking preferences, for example, but each user may write and create it by operation input with appropriate means.

For example, the eating and drinking preference card A is used to have a search condition of preference of meat in food, while the eating and drinking preference card B is used to have a search condition of preference of fish in food. At this time, when the eating and drinking preference cards A, B are placed on the reading portion 101A, which side of the front or back face is directed and placed on the reading portion 101A can be detected (details will be described later).

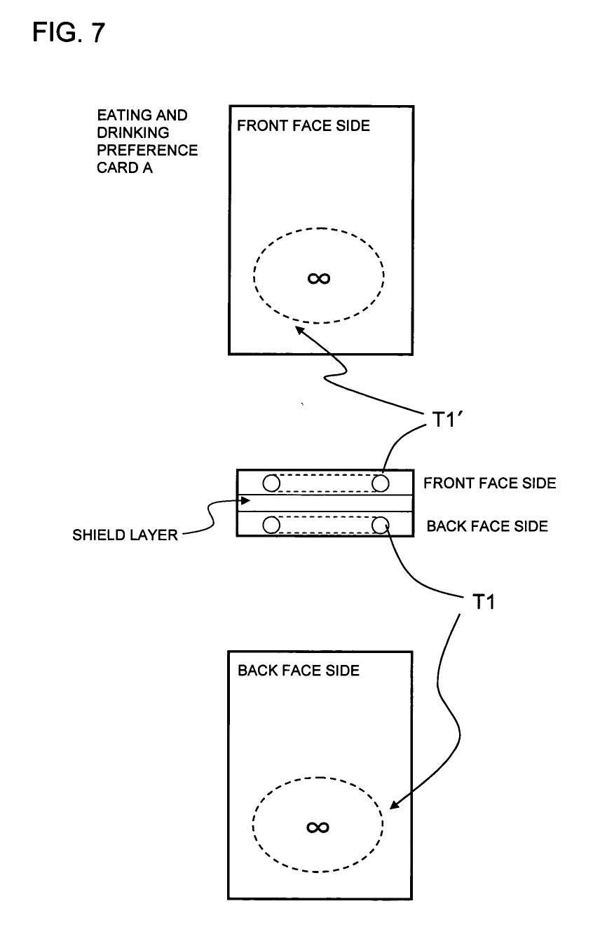

FIG. 7 is an explanatory diagram of the front and back faces of the eating and drinking preference card (eating and drinking preference card A in this example) shown in the above-mentioned FIG. 6. As shown in FIG. 7, on the front and back faces of the eating and drinking preference card A, a RFID tag T1′ (back tag for back-face state detection) and the RFID tag T1 (front tag for front-face state detection) are provided, respectively, with a shield layer made of an appropriate material that can shield or reduce radio communication between them, and radio communication with either one of the RFID tag T is made possible by the shield layer. As a result, if the eating and drinking preference card A is placed on the reading portion 101A with the front face upward, only the RFID tag (front tag) T1 on the back face side below the shield layer can communicate with the antenna 8, while if the eating and drinking preference card A is placed on the reading portion 101A with the back face upward, only the RFID tag (back tag) T1′ on the front face side below the shield layer can communicate with the antenna 8, and which of the front and back faces is directed and placed on (or touched, brought close to) the reading portion 101A of the search apparatus 100 can be detected.

Instead of provision of the RFID tag T on the front and back faces of the eating and drinking preference cards A, B, respectively, the RFID tag T may be provided up and down and right and left and the like on one face (front face, for example), respectively. In this case, according to a state (how to place such as upside down, laterally and the like) where the eating and drinking preference cards A, B are placed on (or touched, brought close to) the reading portion 101A of the search apparatus 100, which of the front or back face is directed placed on (or touched, brought close to) the reading portion 101A of the search apparatus 100 can be detected. In this case, a labor of a user to reverse the eating and drinking preference cards A, B and the like can be omitted.

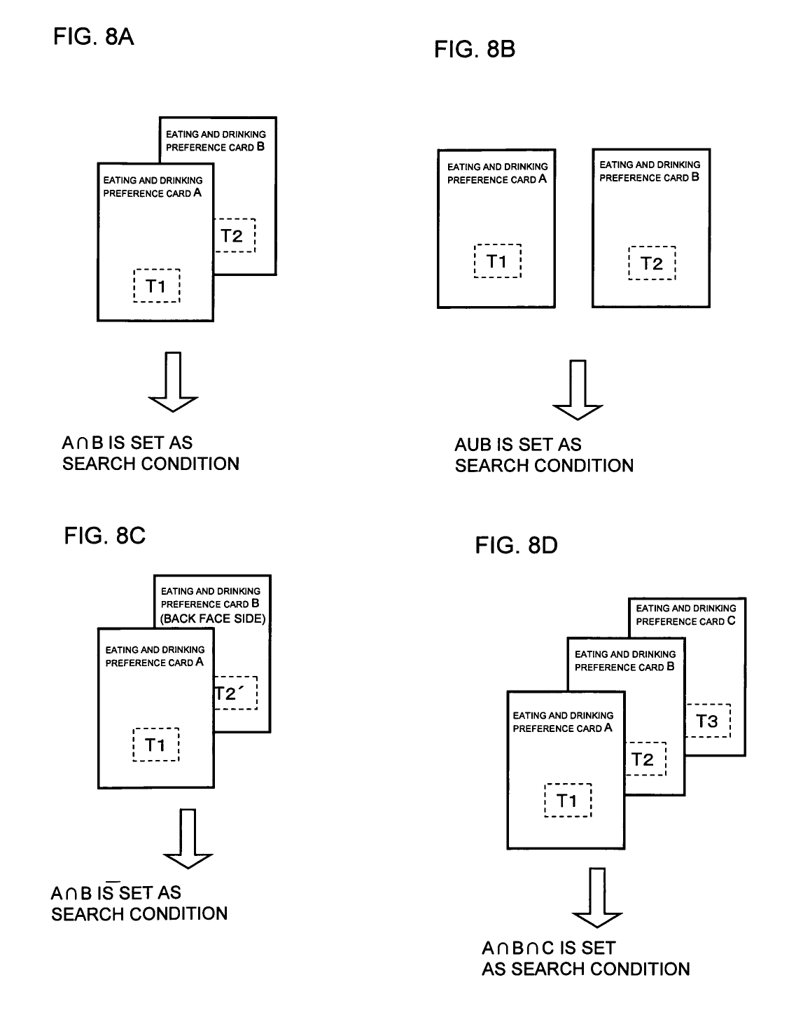

FIGS. 8A to 8D are explanatory diagrams for explaining how to make search from the preference information read out of the eating and drinking preference cards A, B on the basis of the placed state of the eating and drinking preference cards A, B (how they are placed), respectively, when the eating and drinking preference cards A, B in the above-mentioned FIG. 6 are placed on the reading portion 101A.

FIG. 8A shows a case where the eating and drinking preference card A and the eating and drinking preference card B are placed overlapping with each other. When the eating and drinking preference cards A, B are placed overlapping with each other as above, a logical product A∩B of the both preference information (preference of “fond of meat” and “fond of fish” in this example) is set as a search condition.

FIG. 8B shows a case where the eating and drinking preference card A and the eating and drinking preference card B are placed separately (not overlapping with each other). If the eating and drinking preference cards A, B are mounted separately from each other as above, a logical sum AUB of the both preference information (preference of “fond of meat” or “fond of fish” in this example) is set as a search condition.

FIG. 8C shows a case where the eating and drinking card B is reversed (in a state where the eating and drinking preference card B is placed on the reading portion 101A with the back face upward) and placed overlapping with the eating and drinking preference card A. Here, when the card is reversed and placed, logical NOT of the preference information is set as a search condition, and in this case, since the eating and drinking preference card B is reversed, preference of [NOT]B (complementary set of B is noted as this in this Description), that is, not “fond of fish”, that is, “dislike fish” is indicated. And if the reversed eating and drinking preference card B and the eating and drinking preference card A are placed overlapping with each other, their logical product is indicated as mentioned above, and a logical product of the both preference information indicated by these two cards, respectively, A∩[NOT]B (“fond of meat” and “dislike fish” in this example) is set as a search condition.

FIG. 8D shows a case where three eating and drinking preference cards A, B, C including a new eating and drinking card C (detailed preference information is not shown) are placed overlapping. In this case, too, similar to FIG. 8A, the logical product A∩B∩C of the preference information of the respective eating and drinking preference cards A, B, C is set as a search condition.

Though not particularly shown, if the eating and drinking preference cards A, B are placed overlapping with each other and the eating and drinking preference card C is placed separately from them, a logical product of the preference information of the eating and drinking preference cards A, B and a logical sum with the preference information of the eating and drinking preference card C is set as a search condition (A∩BUC=[A∩B]UC). Also, if both the eating and drinking preference cards A, B are placed in a reversed state overlapping with each other, a logical product of a logical NOT of the preference information of the eating and drinking preference card A and a logical NOT of the preference information of the eating and drinking preference card B ([NOT]A∩[NOT]B) is set as a search condition. Similarly, if the eating and drinking preference cards A, B are both reversed and placed separately, a logical sum of the logical NOT of the preference information of the eating and drinking preference card A and the logical NOT of the preference information of the eating and drinking preference card B ([NOT]AU[NOT]B) is set as a search condition.

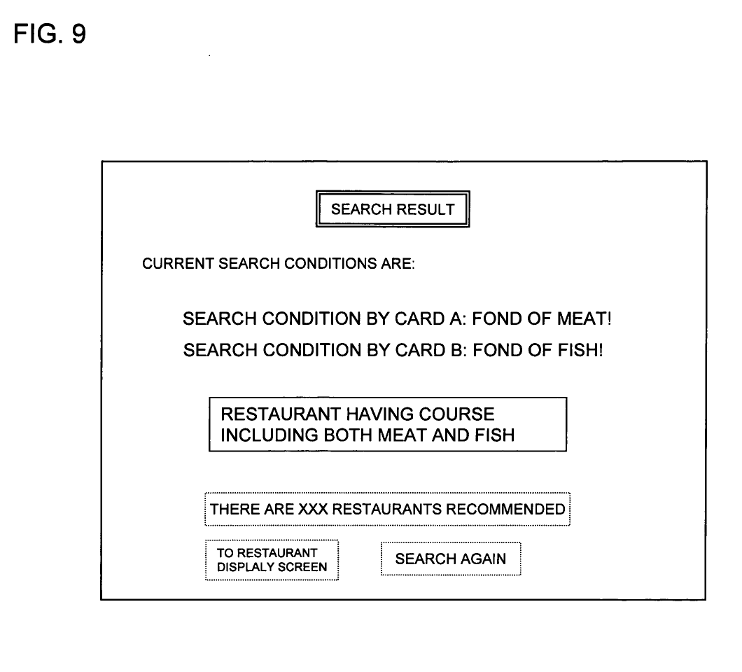

FIG. 9 is a diagram illustrating an example of a screen displayed on the display portion 140 in which preference information selected as a search result from the respective preference information of the eating and drinking preference cards A, B, C, and the like (hereinafter simply referred to as eating and drinking preference cards A, B) as a determination result as described in FIG. 8. In this example, a case where a search was made on a menu of a course meal in a restaurant is shown, and this is particularly an example of a screen corresponding to the search condition set in the above-mentioned FIG. 8A. As shown in the figure, such a state is shown that the logical product A∩B (“fond of meat” and “fond of fish”) of the preference information corresponding to the eating and drinking preference card A (fond of meat) and the preference information corresponding to the eating and drinking preference card B (fond of fish) is set as a search condition, and as a restaurant satisfying the condition, restaurants having both meat and fish included in the course meal are selected as recommended restaurants (the number of applicable shops is shown).

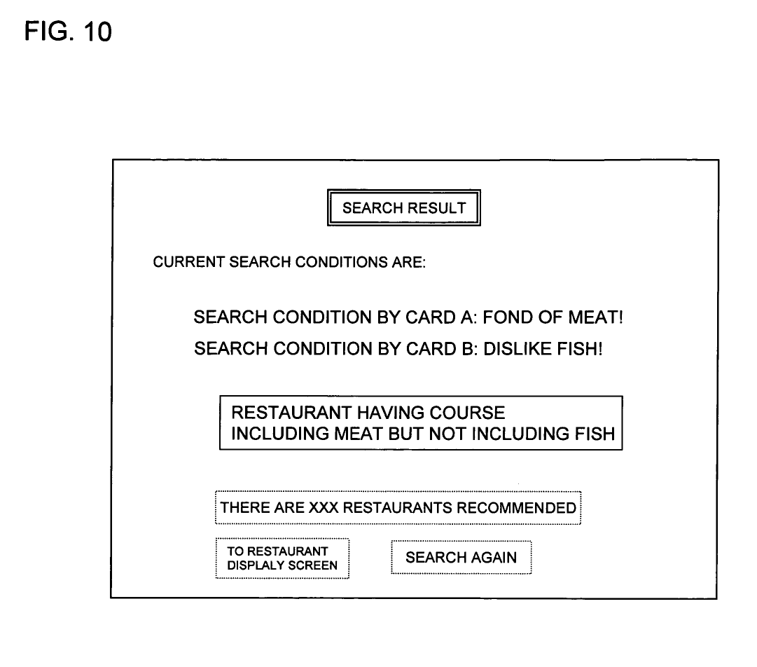

FIG. 10 is an example of a screen corresponding to a search condition set in the above-mentioned FIG. 8C. As shown in the figure, such a state is shown that the logical product A∩[NOT]B (“fond of meat” and “dislike fish”) of the preference information (fond of meat) corresponding to the eating and drinking preference card A and the preference information corresponding to the eating and drinking preference card B (reversed state) (dislike fish) is set as a search condition, and as a restaurant satisfying the condition, restaurants having meat included but fish not included in a course meal is selected as recommended.

In the above two screens, a “to restaurant display screen” button to display an applicable restaurant information is provided. If a user intends to have the applicable restaurant information displayed and operates the “to restaurant display screen” button through an operation of the operation portion 110, information of the applicable restaurant is displayed (not shown).

Also, a “search again” button to make a search again is provided. If a user intends to make a search again (such as a case where a mounted state of at least one of the cards A, B is to be changed to change the search condition and the like) and operates the “search again” button through the operation portion 110, display such as “Place eating and drinking preference card again” and the like is made, for example, though not particularly shown.

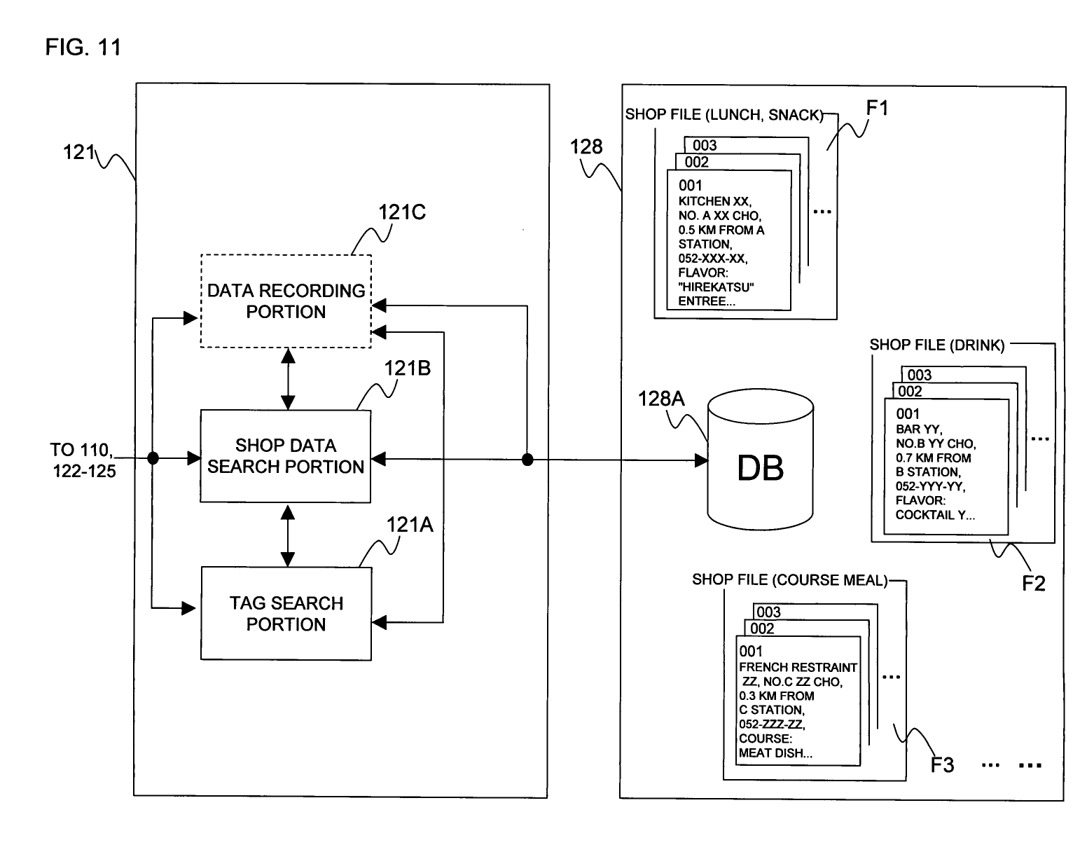

FIG. 11 is a functional block diagram illustrating functional configuration of the CPU 121 and the storage device 128 provided at the control part 120.

In FIG. 11, the CPU 121 is provided with a tag search portion 121A configured to carry out radio communication with the RFID circuit element To relating to the above-mentioned eating and drinking preference cards A, B and to perform control to read out a tag ID, preference information and the like and a shop data search portion 121B configured to search a file (shop file) to which shop data matching a predetermined search result (See FIG. 7) acquired from the preference information belongs from a database 128A in the storage device 128 on the basis of the eating and drinking preference information data detected by the reading-out. A data recording portion 121C may be provided separately that performs processing to write information relating to a shop corresponding to the above search result and new preference information (additional preference information) in the IC circuit part 150 of the RFID circuit elements To relating to the eating and drinking preference cards A, B.

In the database DB 128A in the storage device 128, shop files F1, F2, F3 are provided in a folder format, for example, as shown in the figure in this example.

The shop files F1 to F3 record restaurants as shop data (shop information) at a certain point of time and in this example, file number of each file (001, 002 and the like), shop name, location information, telephone number information, recommended menu (typical specialties of the restaurant) and the like are recorded as shown in the figure. The information is updated with a predetermined time interval by calculation processing of the CPU 121 on the basis of a signal from the communication network NW through the network communication control part 122, for example.

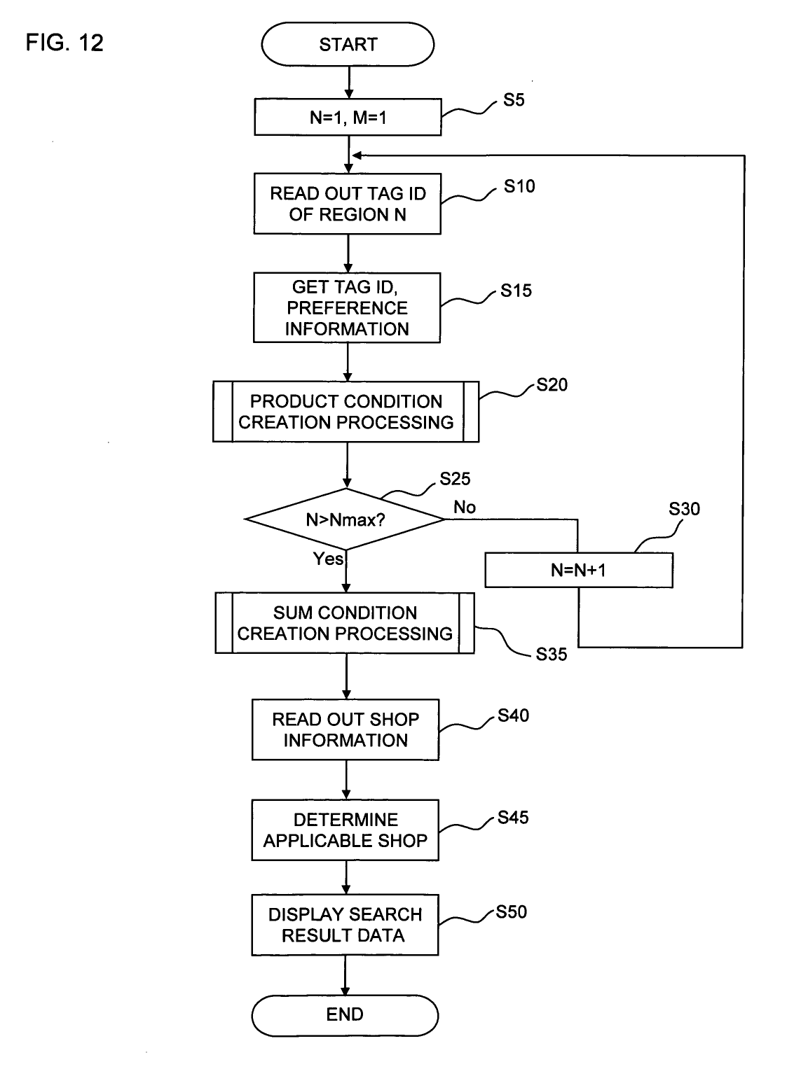

FIG. 12 is a flowchart illustrating a control procedure executed by the CPU 121 in the control part 120 in order to present recommended restaurant information as mentioned above.

In FIG. 12, first, at Step S5, a region number N (variable individually specifying regions 1 to 12 constituted by the tag search region 7a, details will be described later) in the reading portion 101A is set to N=1 (initial value) and a search condition number M (variable individually specifying a search condition created at each tag search region, details will be described later) is set to M=1 (initial value).

Subsequently, the routine goes to Step S10, where at the tag search portion 121A, a control signal is outputted to the above-mentioned antenna switch portion 314 so as to switch the antenna 8 to any of the region number N=1 to 12 (regions 1 to 12, see FIG. 2A) (first, N=1). And through the communication control part 124 and the antenna 8, a call signal to the RFID circuit element To in the applicable region number N is outputted, signal transmission/receiving via radio communication is performed, and RFID tag information and the like including the respective tag ID and the like stored in the IC circuit part 150 of the RFID circuit element To relating to the eating and drinking preference cards A, B are read out.

Specifically, a “TX_ASK” signal is created and outputted to the transmission multiplying circuit 216 so that corresponding amplitude modulation is carried out at the transmission multiplying circuit 216 to become the above call signal as access information, while a “TX_PWR” signal is created and outputted to the variable transmission amplifier 217 so that the signal is amplified at the variable transmission amplifier 217 by an amplification factor based on the “TX_PWR” signal and finally transmitted through the antenna 130. As mentioned above, a reply from the RFID circuit element To of the RFID tag T as a target is prompted, and a response (reply) signal including the RFID tag information and the like including the tag ID and the like is received.

Subsequently, the routine goes to Step S15, where at the tag search portion 121A, according to the response signal receiving result at Step S10, the tag ID and preference information corresponding to each of the eating and drinking preference cards A, B is acquired (extracted). Also, even if neither of the eating and drinking preference cards A, B is placed on the region number N, information is acquired as blank information data (blank set data). The information (including tag ID) read out at this time is once stored in the memory 123.

Subsequently, at Step S20, at the shop data search portion 121B, a product condition creation processing (details will be described later) is performed. Then, at Step S25, at the shop data portion 121B, it is determined if the N=Nmax (Nmax=12 in this example) as the final tag search region has been reached. If the region number N has not reached the Nmax yet at this time, the determination is not satisfied, and the routine goes to Step S30, where 1 is added to N, and the routine returns to Step S10, where the similar procedure is repeated.

If the region number N has reached Nmax, the determination at Step S25 is satisfied, and a sum condition creation processing (details will be described later) at Step S35 is carried out.

Subsequently, the routine goes to Step S40, where at the shop data search portion 121B, an access is made to the database 128A in the storage portion 128 (search signal output portion), and information in the applicable shop files are all read out (in the example shown in FIG. 8A, shop data including both meat and fish in the course meal). And it is once stored in the memory 123.

And at Step S45, at the shop data search portion 121B, an applicable shop is determined from the shop files read out at Step S40. If there are a plurality of applicable shops at this time, the number (number of applicable cases) is counted. The applicable shop information may be sorted based on a distance, budget or any other desired keyword and given priority.

Subsequently, at Step S50, at the shop data search portion 121B, a predetermined display control signal is outputted to the display portion 140 through the display control part 125 so that information of a search result (number of applicable cases) is displayed as information for presentation (display signal output portion).

It may be so configured that control is carried out that the detection of the arrangement states of the cards A, B at Step S10 is repeated with a predetermined period (detection control portion) and if, for example, the mounted state of the eating and drinking preference card is changed (such as being removed or mounted on a region with another region number N, for example), the flow at Step S5 and after is executed again from the region 1 in order (ascending order). As a result, since a determination result is automatically updated every time the eating and drinking preference card is newly mounted or a mounted state of the once-mounted eating and drinking preference card is changed, a labor of the operation by the user can be reduced.

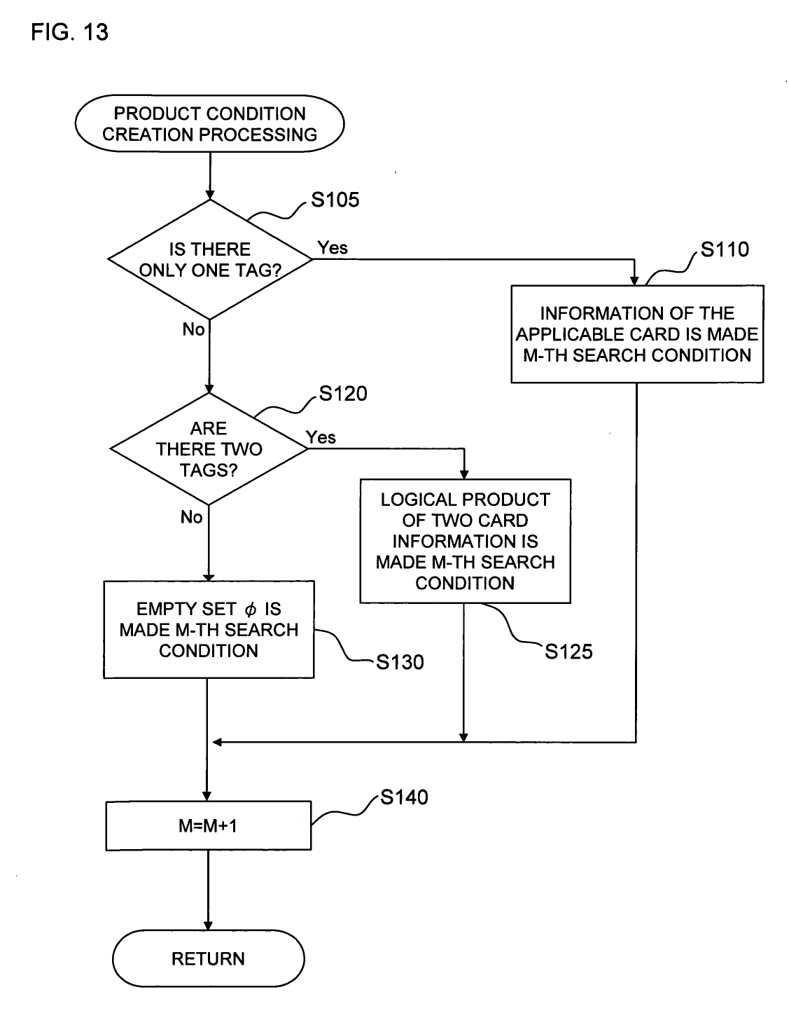

FIG. 13 is a flowchart illustrating a detailed procedure of Step S20.

First, at Step S105, at the shop data search portion 121B, it is determined if the number of read-out tag IDs is single. If the number of read-out tag IDs is single (if the eating and drinking preference card A is mounted, for example), the determination at Step S105 is satisfied, and the routine goes to Step S110.

At Step S110, preference information of the card corresponding to the single tag ID (“fond of meat” in the card A in the above example) is determined as a condition of the M-th search condition number (first, M=1).

On the other hand, if the determination is not satisfied at Step S105, the routine goes to Step S120, where it is determined if the number of read-out tag IDs is two or not. If the number of read-out tag IDs is two (if the eating and drinking preference cards A, B are mounted overlapping with each other, for example), the determination at Step S120 is satisfied, and the routine goes to Step S125.

At Step S125, a logical product of the preference information of the cards corresponding to the two tag IDs, respectively (“fond of meat” in the card A and “fond of fish” in card B, which is “fond of both meat and fish” in the above example) is determined as the condition of the M-th search condition number.

On the other hand, if the determination is not satisfied at Step S120 (no tag ID could be read out), the routine goes to Step S130, where the M-th search condition is made empty set φ (no applicable condition).

At any of Step S110, Step S120, Step S130, if the search condition of the M-th search condition number is determined, the routine goes to Step S140, where 1 is added to the search condition number M and this flow is finished.

By including the empty set φ (no applicable condition) as the search condition of the search condition number M as above, one search condition number M is always associated with a region of an arbitrary region number N (search condition number M=1 to the region 1 with the region numberN=1, . . . , search condition number M=12 to the region 12 with the region number N=12 in this example). Also, a method of determining a search condition when two tag IDs are read out from Step S120 to Step S125 was described but the method can be carried out similarly when three or more tag IDs are read out.

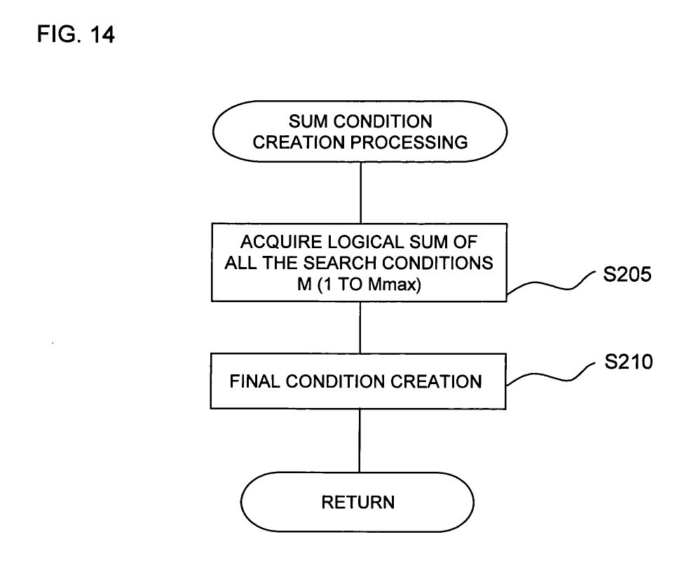

FIG. 14 is a flowchart illustrating a detailed procedure of Step S35.

First, at Step S205, a logical sum of preference information relating to all the search condition numbers M of the search condition number M=1 to Mmax acquired at the product condition creation processing at the above-mentioned Step S20 is calculated. Mmax is a number corresponding to the search condition at the above-mentioned region number Nmax, and it is Mmax=2 in the above-mentioned example.

Subsequently, the routine goes to Step S210, where the logical sum determined at Step S205 is made a final condition Mend. On the basis of Mend (search result) created here, shop information with matched condition is to be searched in the flow at Step S40 and after in the above-mentioned FIG. 11.

In the above, the antenna 8 is provided with the IC circuit part storing information and the tag antenna connected to the IC circuit part and constitutes a communicating device (first communicating device) configured to carry out information transmission/receiving via radio communication with the RFID circuit element (first RFID circuit element) provided at a tag medium described in each claim.

The “meat”, “fish” relating to the search conditions in FIGS. 9 and 10 correspond to text information and further correspond to search element information (operation instruction information). Step S10 and Step S15 in FIG. 12 constitute an information acquisition portion (also constituting a part of an operation instruction processing portion) configured to acquire search element information relating to a corresponding tag medium stored in the IC circuit part in the RFID circuit element through a communicating device. And the antenna 8 constitutes a front/back detecting device that detects an arrangement state of the tag medium and a separation/overlapping detecting device and also constitutes an arrangement detecting device.

Step S20 and Step S35 in FIG. 12 constitute a logical expression creating portion that creates a logical expression for search (also constitute a part of the operation instruction processing portion) on the basis of the search element information acquired by the information acquisition portion and the arrangement state of the tag medium. Among them, Step S20 constitutes a region-specific creating portion that calculates a region-specific logical expression in each communication region and Step S35 constitutes a logical sum creating portion that calculates a logical sum of a plurality of region-specific logical expressions calculated by the plurality of region-specific creating portions, respectively.

And the above-mentioned antenna 8 as communicating device, front/back detecting device, separation/overlapping detecting device, arrangement detecting device, Step S10 and Step S15 as the information acquisition portion, Step S20 as the region-specific creating portion, Step S35 as the logical sum creating portion and the like constitute a logical-expression creating portion (operation processing portion) described in each claim.

As mentioned above, in the search apparatus 100 of the present embodiment, information transmission/receiving is carried out by the antenna 8 with the IC circuit part 150 of the RFID circuit element To in the plurality of eating and drinking preference cards A, B, and further according to the arrangement state (separated or overlapped, reversed or no and the like) of the eating and drinking preference cards A, B at that time, a logical expression for search (A∩B, AUB, A∩[NOT]B and the like) is created. That is, when the search condition is set, a user can automatically create a desired logical expression for search (“fond of both meat and fish”, “fond of at least either of meat or fish”, “fond of meat but dislike fish” and the like, in this example) by arranging the eating and drinking preference cards A, B provided with the search element information (“meat”, “fish” in the above example) corresponding to the condition in an appropriate mode (overlapped, separated, reversed and the like in the above example). Therefore, since the logical expression for making a desired search can be created casually with a simple method without manually setting or inputting a complicated search expression, convenience for a searcher can be drastically improved.

It may be so configured that the logical expression for search created at Step S35 in FIG. 12 is written in a separate RFID circuit element (second RFID circuit element with the configuration equivalent to the first RFID circuit element To. Not shown) provided at a tag feeding body (base tape, sheet and the like made of PET film, thermal paper and the like) fed by an appropriate feeding device (tag feeding body feeding device. Not shown) so as to create a RFID tag for logical expression (with the configuration equivalent to the RFID tags T1, T2 and the like). In this case, the logical expression for search is written in the IC circuit part of the second RFID circuit element through an antenna (second communicating device. Not shown) equivalent to the antenna 8 (writing control portion).

In this case, the logical expression for search created by the operator as a search condition can be written and stored in the second RFID circuit element, and by reading out the stored logical expression for search from the second RFID circuit element later, the search condition can be reproduced easily.

Also, the present embodiment is not limited to the above mode and is capable of various deformations in a range not departing from its gist and technical idea. The variations will be described later in order.

(1-1) Other than Restaurants and the Like:

Restaurants are used in the above as an example of a shop to be searched from eating and drinking preference information of a user, but not limited to that, the present embodiment can be applied to search other articles.

That is, if the embodiment is applied to search of a book and the like in a library or a book shop, for example, by reading out an “issued in 2006” card corresponding to the eating and drinking preference card A (relating to time information such as time, date and the like), a “history novel” card corresponding to the eating and drinking preference card B and the like by the search apparatus 100, a “history novel issued in 2006” can be searched or a “history novel issued in a year other than 2006” can be searched, for example. Also, by using a “U.S.” card and the like relating to location information, a “history novel issued in U.S.” and the like can be also searched.

Also, if the embodiment is applied to search of a desired product (clothes and the like) at a shop selling clothes, similarly to the above, by reading cards by key word such as a “color (red)” card relating to red as color information, “type (suit)” card, “size (9)” card and the like in a desired combination by the search apparatus 100, a “red suit”, for example, can be searched. This search may be directly conducted by a user (consumer) or a representative and the like at a shop serving the consumer may conduct the search by asking the needs of the consumer.

Other than that, the present embodiment can be applied to entertainment purposes such as a game and the like (card game and the like). Other than that, the embodiment can be widely applied to pick-up of common information (keyword) from a plurality of pieces of information (keywords) or narrowing-down with a combination of a plurality of pieces of information as a desired search condition.

(1-2) When Matrix Coil Antenna is Used:

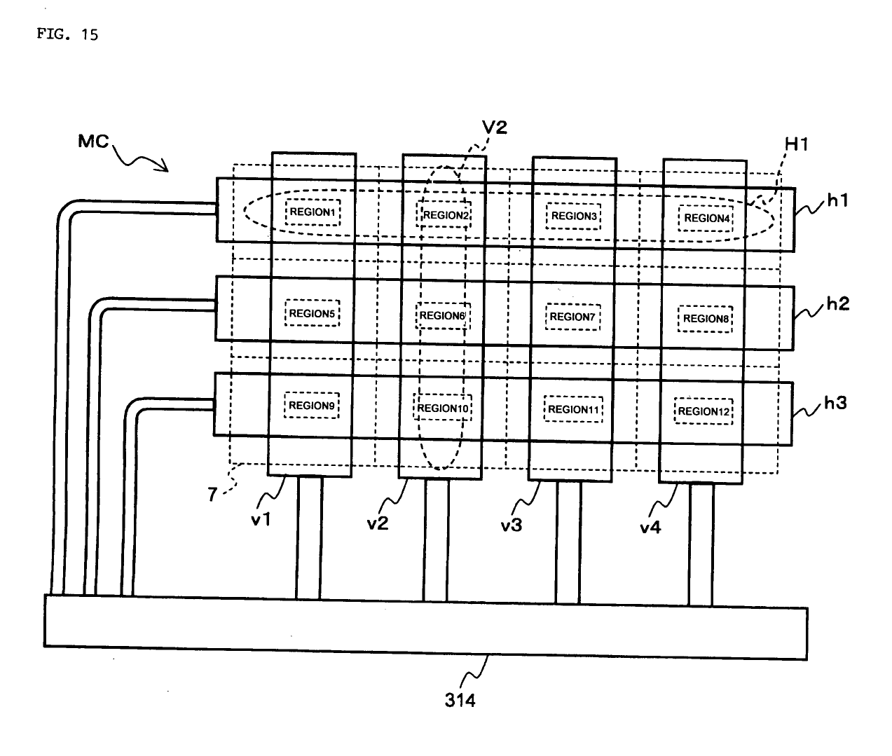

In the above embodiment, as shown in FIG. 2, 12 antennas 8 are arranged in a matrix state so as to correspond to each of the 3×12 detection regions 7a and appropriate switching is made in the ascending order from the above-mentioned region 1 to the region number 12 by the antenna switch portion 314, but not limited to that. That is, as shown in FIG. 15, instead of the above 12 antennas 8, a matrix coil antenna MC consisting of (7 in total in the illustrated example) coil elements h1 to h3 (three in the lateral direction), v1 to v4 (four in the vertical direction) disposed in orthogonal two directions so that they are crossed by each other to be partially overlapped may be used.

For example, by combining a detection result of any of the lateral coil elements h1 to h3 and a detection result of any of the vertical coil elements v1 to v4, a matrix area consisting of 12 regions 1 to 12 in 3×4 can be covered as a result. In the illustrated example, if presence of the RFID circuit element To is detected by the lateral coil element hi and the vertical coil element v2, it represents that the card A (or B) provided with the RFID circuit element To is present in the detection region 7a (region 2), which is a crossed region by a detection area Hi by the lateral coil element h1 and a detection area V2 by the vertical coil element v2. Similarly, in the other regions 1, 3 to 12, too, the presence of the RFID circuit element can be detected by the combination of the detection results of any of the lateral coil elements h1 to h3 and any of the vertical coil elements v1 to v4.

In this variation, since only 7 coil elements are sufficient as compared with a case where 12 antennas 8 are used as in the above embodiment, configuration of the switch portion 314 or routing wiring from each coil element to the switch portion 314 can be simplified.

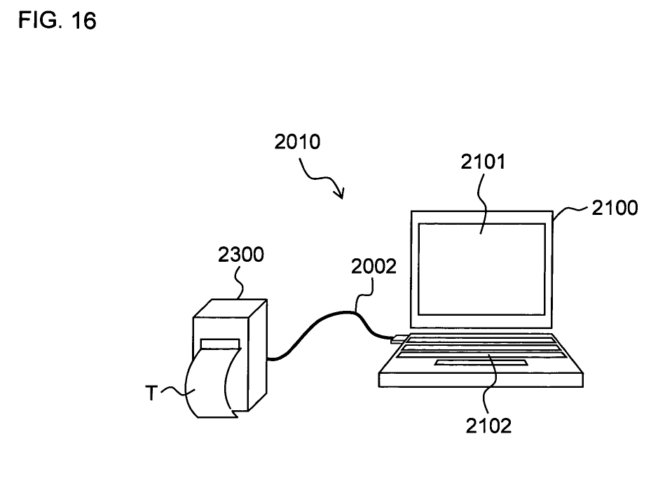

A second embodiment of the present invention will be described referring to FIGS. 16 to 39. The present embodiment is an embodiment when the present invention is applied to an apparatus for producing RFID label as the operation processing apparatus. The same reference numerals are given to portions equivalent to those in the first embodiment and explanation will be omitted or simplified as appropriate.

FIG. 16 is a system block diagram illustrating an entire operation tag manufacturing system including an apparatus 2300 for producing RFID label as the operation processing apparatus of the present embodiment.

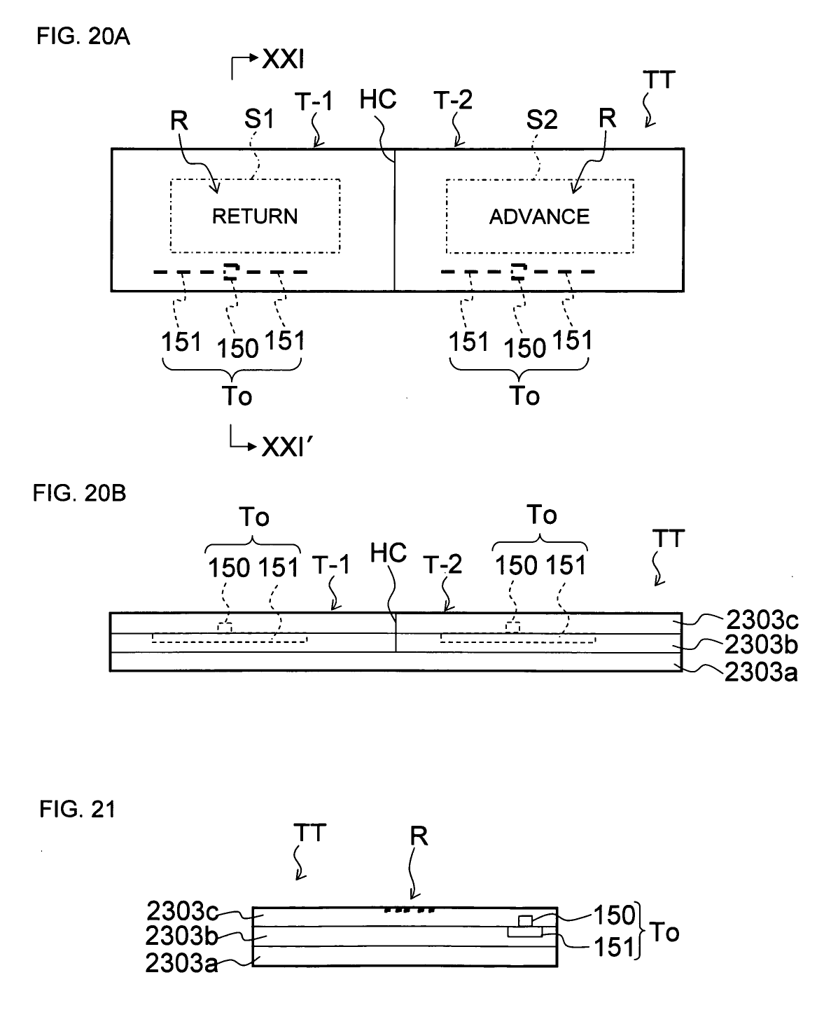

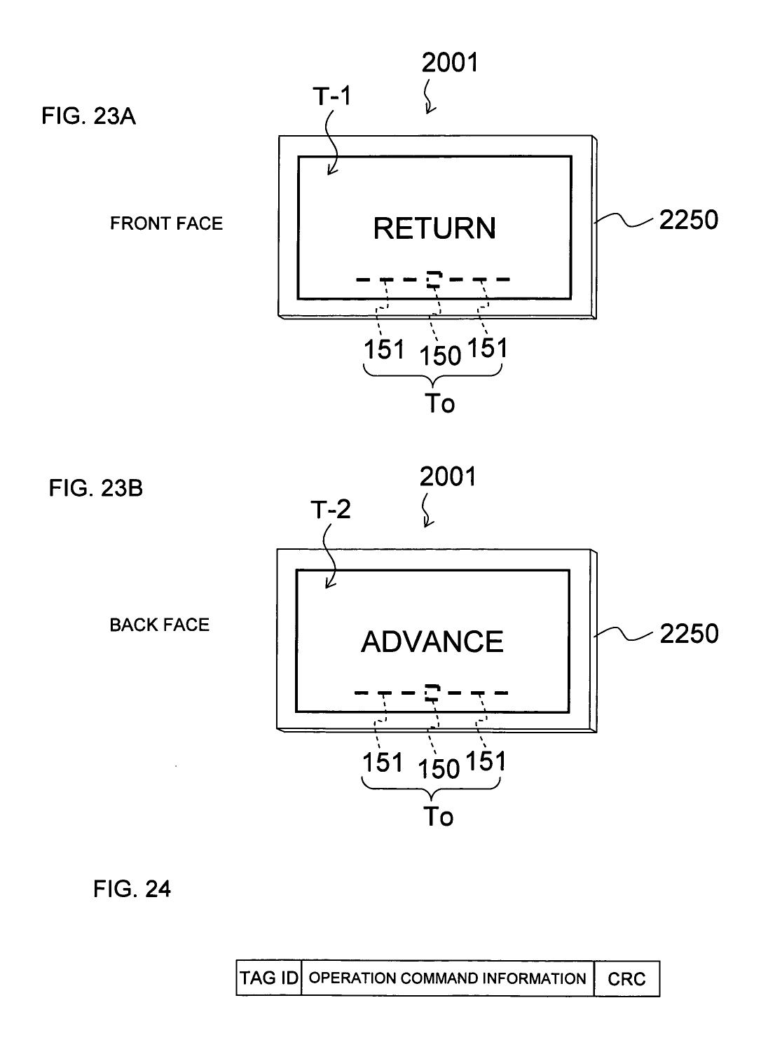

The operation tag manufacturing system 2010 shown in FIG. 16 is provided with the apparatus 2300 for producing RFID label configured to produce a tag label body TT (See FIG. 20, which will be described later) that creates an operation tag 2001 (See FIG. 23, which will be described later) constituted by a plurality of RFID labels having a RFID circuit element To (See FIG. 4) provided with the IC circuit part 150 storing information and the antenna 151 connected to the IC circuit part 150 and having equipment to be operated (such as a projector and the like, for example) carry out a predetermined operation and a PC terminal (personal computer terminal. Hereinafter described as “PC”) 2100 connected to the apparatus 2300 for producing RFID label through a connecting device 2002 such as a USB cable and the like, for example and having the display portion 2101, the operation portion 2102 and the like.

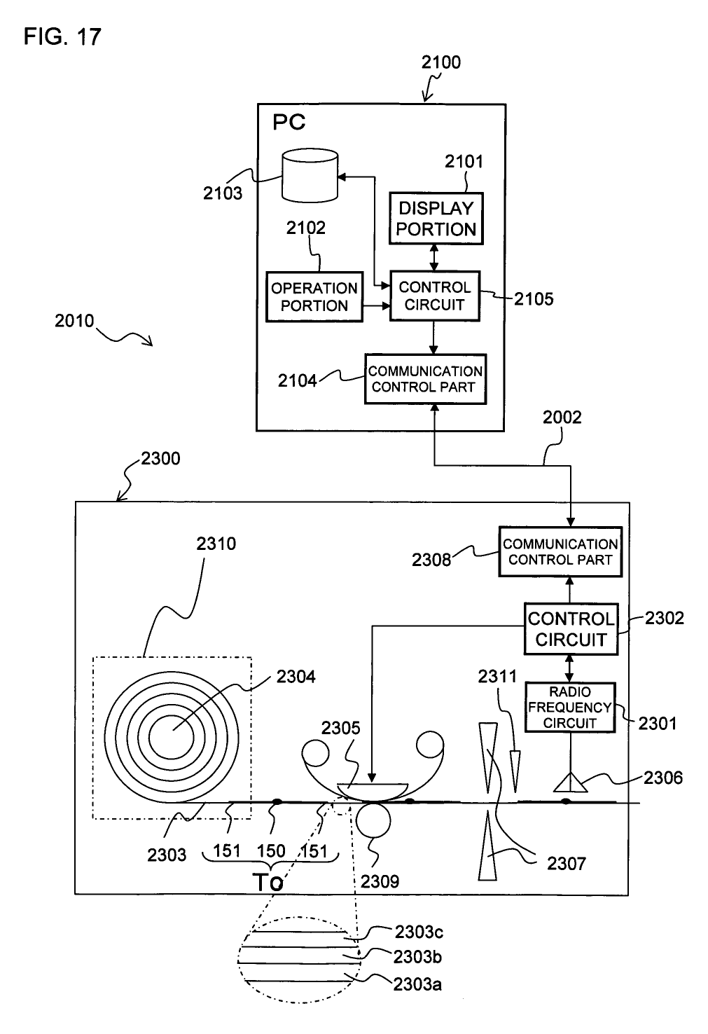

FIG. 17 is a functional block diagram illustrating a detailed function of the PC 2100 and the apparatus 2300 for producing RFID label constituting the operation tag manufacturing system 2010.

In FIG. 17, the PC 2100 has the display portion 2101 that makes a predetermined display such as various input screens and the like, the operation portion 2102 provided with an appropriate button, key, mouse and the like for operation input by an operator, a storage device 2103 such as a hard disk and the like in which various applications, data such as electronic files and the like are stored, a communication control part 2104 that conducts communication control with the apparatus 2300 for producing RFID label through the connecting device 2002, and a control circuit 2105 configured to control an entire operation of the PC 2100 including the display portion 2101, the operation portion 2102, the storage device 2103, and the communication control part 2104.

On the other hand, the apparatus 2300 for producing RFID label has a roll of a tape with RFID tags holder portion 2310 that can detachably attach a roll 2304 of a tape with RFID tags around which a tag tape 2303 (tag carrier body) provided with RFID circuit elements To with a predetermined interval (or detachably attach a cartridge provided with the roll 2304 of a tape with RFID tags) is wound, a print head 2305 (printing device) configured to apply a desired print on a print region S (See FIG. 20, which will be described later) corresponding to the RFID circuit element To in the tag tape 2303 fed out of the roll 2304 of a tape with RFID tags, an antenna 2306 (communicating device) configured to transmit/receive information with the RFID circuit element To via radio communication, a radio frequency circuit 2301 (constituting a writing device and also constituting a part of the operation instruction processing portion) and a control circuit 2302, a communication control part 2308 configured to carry out communication control with the PC 2100 via the connecting device 2002, a cutter 2307 (cutter) configured to cut the tag tape 2303 with which the print on the tag tape 2303 and the information writing on the RFID circuit element To have been finished to a predetermined length so as to have the tag label body TT made of a plurality of RFID labels, a half cutter 2311 (half-cutter) configured to carry out half-cut to cut layers other than a separation sheet 2303a (base film 2303c and an adhesive layer 2303b. See a partially enlarged view in FIG. 17) in the width direction, and a feeding device 2309 (feeding device for tag carrier body) provided opposite the print head 2305 and configured to feed the roll 2304 of a tape with RFID tags under control by the control circuit 2302.

The tag tape 2303 has a three-layered structure consisting of a base film 2303c (base layer), the adhesive layer 2303b (adhesive layer for bonding), and the separation sheet 2303a (separation material layer) from the base film 2303c side (upper side in FIG. 17) to the opposite side (lower side in FIG. 17). The RFID circuit element To provided with the IC circuit part 150 storing information and the antenna 151 (tag antenna) connected to the IC circuit part 150 is provided on the back side of the base film 2303c (lower side in FIG. 17) (See FIG. 20, which will be described later). A heat sensitizing agent that develops color by heating is applied on the surface of the base film 2303c, and by heating by a print element of the print head 2305, a print R (See FIG. 20, which will be described later) is printed on the surface of the base film 2303c.

The radio frequency circuit 2301 and the control circuit 2302 creates access information to the IC circuit part 150 of the RFID circuit element To, transmits it to the RFID circuit element To through the antenna 2306, and writes information in the IC circuit part 150 of the RFID circuit element To. The control circuit 2302 is connected to the PC 2100 through the connecting device 2002 and is capable of information transmission/receiving with the PC 2100.

In such configuration, when the tag label body TT is to be created by the apparatus 2300 for producing RFID label, an operator carries out setting input of an operation command corresponding to equipment to be operated by the operation tag 2001 and to an operation to be carried out by the equipment using the operation portion 2102 of the PC 2100 and makes a production instruction input of the tag label body TT. As a result, at the PC 2100, tag data and print data for the front face and the back face of the operation tag 2001 are created, respectively, and the data is transmitted to the apparatus 2300 for producing RFID label through the connecting device 2002. As a result, by control by the control circuit 2302 of the apparatus 2300 for producing RFID label, a print on the front face/back face by the print head 2305 on the basis of the print data is applied, respectively, and the access information corresponding to the operation command is created by the radio frequency circuit 2301 and transmitted to the RFID circuit elements To corresponding to the front face/back face, respectively, through the apparatus antenna 2306. As a result, information corresponding to the operation command is written in the IC circuit parts 150 of the RFID circuit elements To corresponding to the front face/back face, respectively, and the tag label body TT is created.

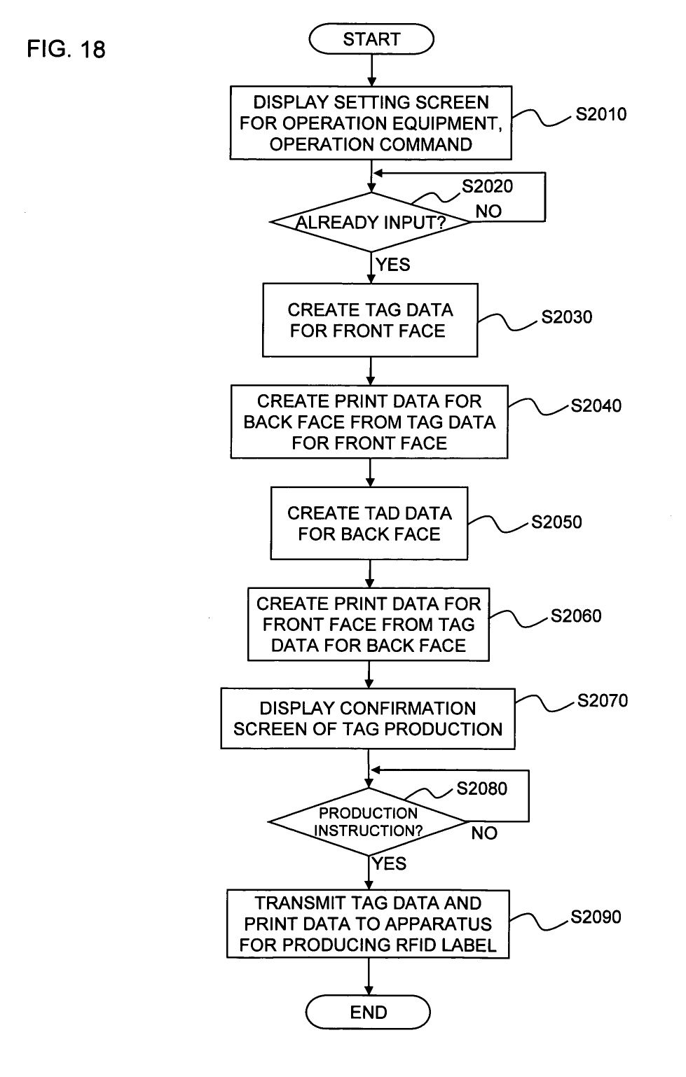

FIG. 18 is a flowchart illustrating a control procedure executed by the control circuit 2105 of the PC 2100 at setting input of the operation equipment and the operation command. The control circuit 2105 starts this flow when the operator makes a production instruction input of the appropriate operation tag 2001 (tag label body TT).

In FIG. 18, first, at Step S2010, a control signal is outputted to the display portion 2101 so that an input screen of the equipment to be operated of the operation tag 2001 and the operation command corresponding to the operation to be carried out by the equipment is displayed and an input by the operator is prompted. The input of the tag operation equipment and the operation command is made by selection and input by the operator through the operation portion 2102 from the formats prepared in plural and determined in advance such as a login/logout operation to the PC or a user switching operation and a moving operation and the like of a projection image (made of a plurality of images) to a projector, for example.

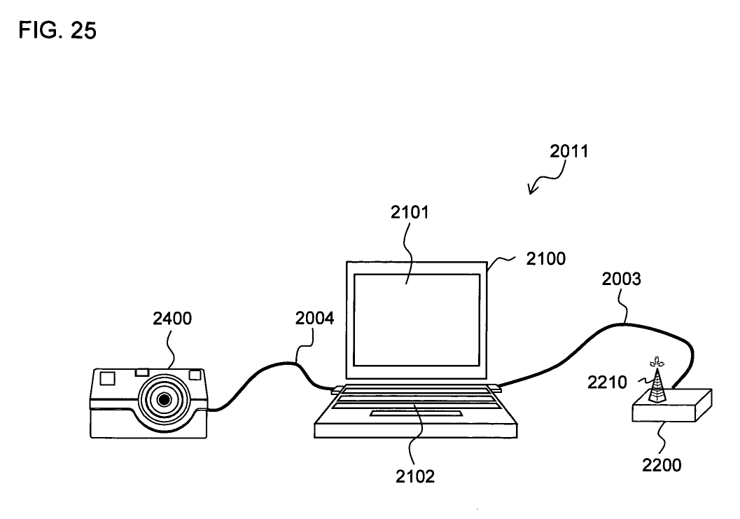

A case where a projector 2400 (See FIG. 25, which will be described later) as the equipment to be operated and inputs of two operation commands of a “advance” command to move a projection image (configured from a plurality of slides) of the projector 2400 to the subsequent slide and a “return” command to return the projection image to the previous slide as the operation command will be described as an example.

At the subsequent Step S2020, according to the above operation equipment/operation command setting screen, it is determined if command information has been inputted by the operator using the operation portion 2102. If the command information has been inputted, the determination is satisfied, and the routine goes to the subsequent Step S2030.

At Step S2030, either one of the two commands (“advance” “return” commands) inputted at Step S2020 is selected and on the basis of the command, tag data for front face to be written in the RFID circuit element To attached on the surface of the operation tag 2001 is created. Here, suppose that the “advance” command is selected as the command for the front face.

At the subsequent Step S2040, on the basis of the tag data for front face created at Step S2030, print data to be printed on the RFID label T attached on the back face of the operation tag 2001 is created. Here, corresponding to the “advance” command, the print data made of a text of “advance”, for example, is created.

At the subsequent Step S2050, the other of the two commands (“advance” “return” commands) inputted at Step S2020 is selected, and on the basis of the command, tag data for back face to be written in the RFID circuit element To attached on the back face of the operation tag 2001 is created. Here, suppose that the “return” command is selected for the command for the back face.

At the subsequent Step S2060, on the basis of the tag data for back face created at Step S2050, the print data to be printed on the RFID label T attached on the front face of the operation tag 2001 is created. Here, corresponding to the “return” command, the print data made of characters of “return”, for example, is created.

At the subsequent Step S2070, a control signal is outputted to the display portion 2101 so that a final confirmation screen on whether the operation tag 2001 (tag label body TT) is to be produced or not is displayed and an input from the operator of the tag production instruction is prompted.

At the subsequent Step S2080, according to the above confirmation screen, it is determined if the production instruction input of the operation tag 2001 (tag label body TT) has been made by the operator using the operation portion 2102. If there has been an input of the creation instruction, the determination is satisfied, and the routine goes to the subsequent Step S2090.

At Step S2090, through the communication control part 2104 and the connecting device 2002, to the control circuit 2302 of the apparatus 2300 for producing RFID label, the tag data and the print data corresponding to the above-created front face/back face, respectively, are transmitted. And this flow is finished.

Though not particularly described in the above flow, it may be so configured that a cancellation operation can be made by an operator in each input screen and the like. Also, the tag operation equipment and operation command is selected from preset formats in the above, but not limited to that, it may be so configured that an operator can set and input an arbitrary tag operation equipment and operation command. Moreover, the print data is automatically created on the basis of the tag data in the above, but not limited to that, it may be so configured that an operator can set an arbitrary print data by manual input.

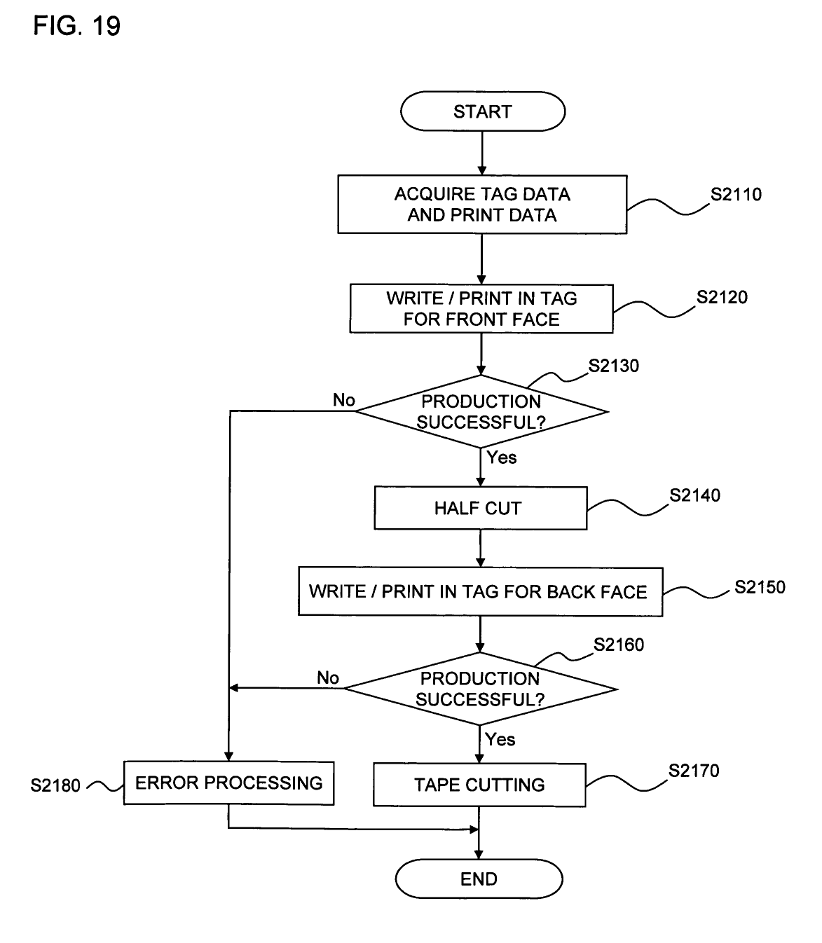

FIG. 19 is a flowchart illustrating a control procedure executed by the control circuit 2302 of the apparatus 2300 for producing RFID label at production of the operation tag 2001 (tag label body TT). The control circuit 2302 starts this flow when it receives the tag data and print data transmitted from the control circuit 2105 of the PC 2100 at Step S2090.

First, at Step S2110, on the basis of the received data from the PC 2100, the tag data and print data corresponding to the front face/back face of the operation tag 2001 is acquired, respectively.

At the subsequent Step S2120, the access information is created by the radio frequency circuit 2301 and transmitted to the RFID circuit element To corresponding to the surface of the operation tag 2001 through the apparatus antenna 2306, and the tag data acquired at Step S2110 (including information corresponding to the above “advance” command) is written in the IC circuit part 150. Also, on the basis of the print data (character data of “return” in this example) acquired at Step S2110, a print by the print head 2305 is applied on the print region S1 (first print region. See FIG. 20, which will be described later) corresponding to the surface of the operation tag 2001.

At the subsequent Step S2130, it is determined if production of the RFID label T corresponding to the surface has been successful or not, in other words, if writing of the tag data in the RFID circuit element To has been successful or not. Specifically, a “Verify” signal is transmitted to the RFID circuit element To and on the basis of a reply signal received from the RFID circuit element To in response to that, information stored in the memory part 150 of the RFID circuit element To is confirmed and using a known error detection code (CRC code: Cyclic Redundancy Check or the like), it is determined if the information corresponding to the operation command has been normally stored in the memory part 150 or not. If the tag label production has been successful, the determination is satisfied, and the routine goes to the subsequent Step S2140.

At Step S2140, by outputting a control signal to a driving circuit, not shown, the half-cutter 2311 is driven and half-cut to cut the layers other than the separation sheet 2303a (the adhesive layer 2303b and the base film 2303c) in the tag tape 2303 in the width direction is carried out.

At the subsequent Step S2150, the access information is created by the radio frequency circuit 2301 and transmitted to the RFID circuit element To corresponding to the back face of the operation tag 2001 through the apparatus antenna 2306, and the tag data (including the information corresponding to the above “return” command) acquired at Step S2110 is written in the IC circuit part 150. Also, on the basis of the print data (text data of “advance” in this example) acquired at Step S2110, the print is applied by the print head 2305 on the print region S2 (first print region. See FIG. 20, which will be described later) corresponding to the back face of the operation tag 2001.

At the subsequent Step S2160, it is determined if the production of the RFID label T corresponding to the back face has been successful or not similarly to Step S2130. If the tag label production has been successful, the determination is satisfied, and the routine goes to the subsequent Step S2170.

At Step S2170, by outputting a control signal to the driving circuit, not shown, the cutter 2307 is driven and tape cutting is carried out so as to produce a plurality of the (two, in this example) tag label bodies TT provided with the RFID label T (RFID circuit element To), and this flow is finished.

At Step S2130 or Step S2160, if the production of the RFID label T corresponding to the front face or back face has not been successful, the determination is not satisfied, and the routine goes to Step S2180, respectively. At Step S2180, an error display signal is outputted to the control circuit 2105 of the PC 2100 through the communication control part 2308 and the connecting device 2002 so as to make corresponding failure display (“tag production has not been successfully finished” and the like, for example) on the display portion 2101. And this flow is finished.

FIGS. 20A and 20B are views illustrating an example of an appearance of the tag label body TT formed by completing information writing/print in the RFID circuit element To corresponding to the front face/back face of the operation tag 2001, respectively, as mentioned above and cutting of the tag tape 2303, in which FIG. 20A is a top view, and FIG. 20B is its side view seen from the lower direction in FIG. 20A. FIG. 21 is a lateral sectional view by XXI-XXI′ section in FIG. 20A.

In FIGS. 20A, 20B, and 21, the tag label body TT has two RFID labels of a RFID label T-1 corresponding to the front face of the operation tag 2001 and a RFID label T-2 corresponding to the back face, and as mentioned above, it is constituted by three layers of the base film 2303c, the adhesive layer 2303b, and the separation sheet 2303a from the side of the base film 2303c (upper side in FIG. 20) to the opposite side (lower side in FIG. 20). And in the RFID labels T-1, T-2, the RFID circuit element To provided with the antenna 151 provided on the back side of the base film 2303c and the IC circuit part 150 provided in the base film 2303c or the adhesive layer 2303b (in the base film 2303c in the figure) and in which the information corresponding to the operation command has been written is arranged in a biased manner on one side in the width direction (lower side in FIG. 20), respectively, and the print R (characters of “return”, “advance” in this example) is printed, respectively, by the print head 2305 on the print regions S1, S2 on the front face of the base film 2303c.

Between the RFID label T-1 and the RFID label T-2, a half-cut line HC (first half-cut portion) is formed by cutting the layers other than the separation sheet 2303a (base film 2303c and the adhesive layer 2303b) by the above-mentioned half-cutter 2311, by which the tag label body TT is configured such that the RFID labels T-1, T-2 are connected via the separation sheet 2303a at the position of the half-cut line HC.

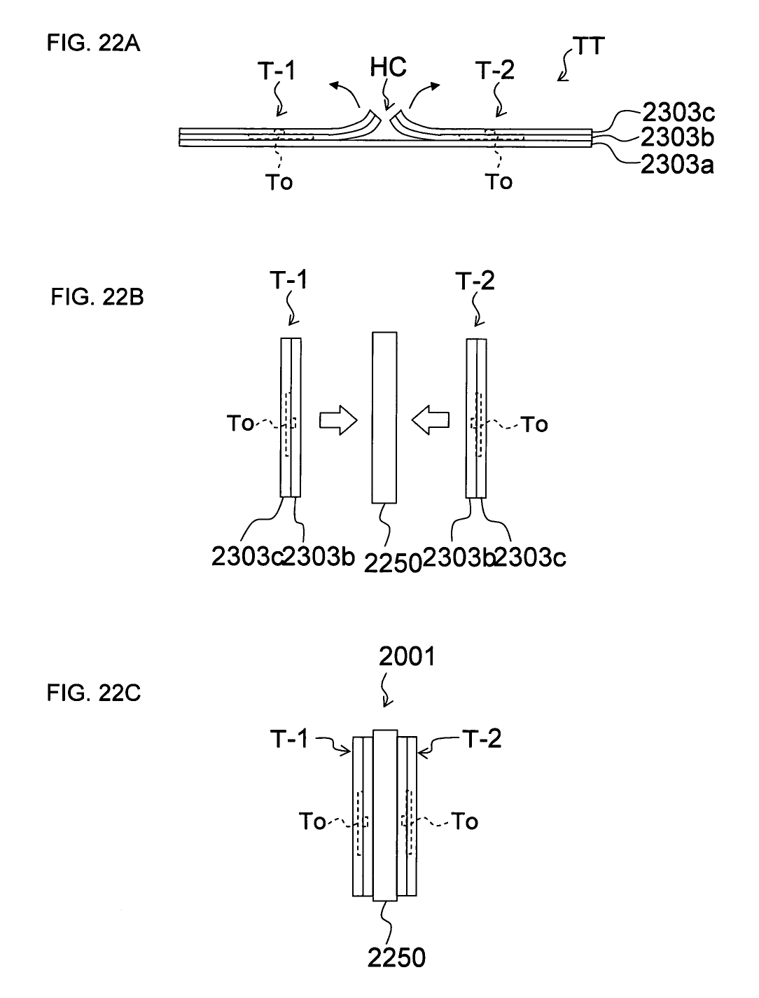

FIGS. 22A to 22C are diagrams illustrating a procedure to produce the operation tag 2001 using the RFID labels T-1, T-2 constituting the above RFID label body TT produced by the apparatus 2300 for producing a RFID label.

First, as shown in FIG. 22A, in the tag label body TT produced by the apparatus 2300 for producing a RFID label, each of the RFID labels T-1, T-2 (more accurately, the base film 2303c and the adhesive layer 2303b portion other than the separation sheet 2303a in each of the RFID labels T-1, T-2) is peeled off the separation sheet 2303a using the half-cut line HC.

And as shown in FIGS. 22B and 22C, to a base material 2250 constituted by an insulating body such as plastic and the like and formed substantially in a square thin-plate shape, the RFID label T-1 is attached to a face of its one side (to be the front face) and the RFID label T-2 is attached to a face of the other side (to be the back face) so as to produce the operation tag 2001. By constituting the base material 2250 by the insulating body, at radio communication between the antenna 2210 of a reader 2200, which will be described later, and the RFID circuit element To of each of the RFID labels T-1, T-2, interference which would affect communication can be suppressed.

FIGS. 23A and 23B are a top view and a bottom view illustrating an example of an entire outline structure of the operation tag 2001 produced as above.

In FIGS. 23A and 23B, the operation tag 2001 is formed in a card state and is constituted by the substantially square thin-plate shaped base material 2250, the RFID label T-1 attached on the front face of the base material 2250 and on which the characters of “return” is printed, and the RFID label T-2 attached on the back face of the base material 2250 and on which the characters of “advance” is printed.

Since functional configuration of the RFID circuit element To provided at the RFID labels T-1, T-2 is sufficient with those similar to the description using FIG. 4 in the first embodiment, illustrating and detailed explanation will be omitted. That is, these RFID circuit elements To have the antenna 151 (tag antenna) that carries out transmission/receiving of a signal in a non-contact manner using a radio frequency such as short wave band (13.56 MHz, for example), UHF band or microwave band with the antenna 2306 of the apparatus 2300 for producing a RFID card and the antenna 2210 of the reader 2200 provided with a reading function of the RFID circuit element To, which will be described later and the IC circuit part 150 connected to the antenna 151.

FIG. 24 is a diagram illustrating an example of data configuration of the memory part 155 in the IC circuit part 150 of the RFID circuit element To in the RFID labels T-1, T-2 constituting the tag label body TT produced by the apparatus 2300 for producing a RFID label.

In the example shown in FIG. 24, the data stored in the memory part 155 of the IC circuit part 150 in the RFID circuit element To is constituted by a tag ID, which is identification information specific to the RFID circuit element To, information corresponding to the operation command for having the equipment to be operated (projector 2400, here) carry out a predetermined operation, and the error detection code CRC (Cyclic Redundancy Check) indicating validity of the data.

FIG. 25 is a system block diagram illustrating an entire RFID tag operation system including the reader 2200 of the present embodiment.

The RFID tag operation system 2011 shown in FIG. 25 is provided with the reader 2200 (RFID tag information reading device) having the antenna 2210 that reads out information via radio communication from the operation tag 2001 produced by the apparatus 2300 for producing a RFID label, the PC 2100 connected to the reader 2200 via a connecting device 2003 such as a USB cable and the like, for example, and having the display portion 2101 and the operation portion 2102 and the like, and the projector 2400 connected to the PC 2100 via a connecting device 2004 such as the USB cable and the like, for example, and projecting image data outputted from the PC 2100.

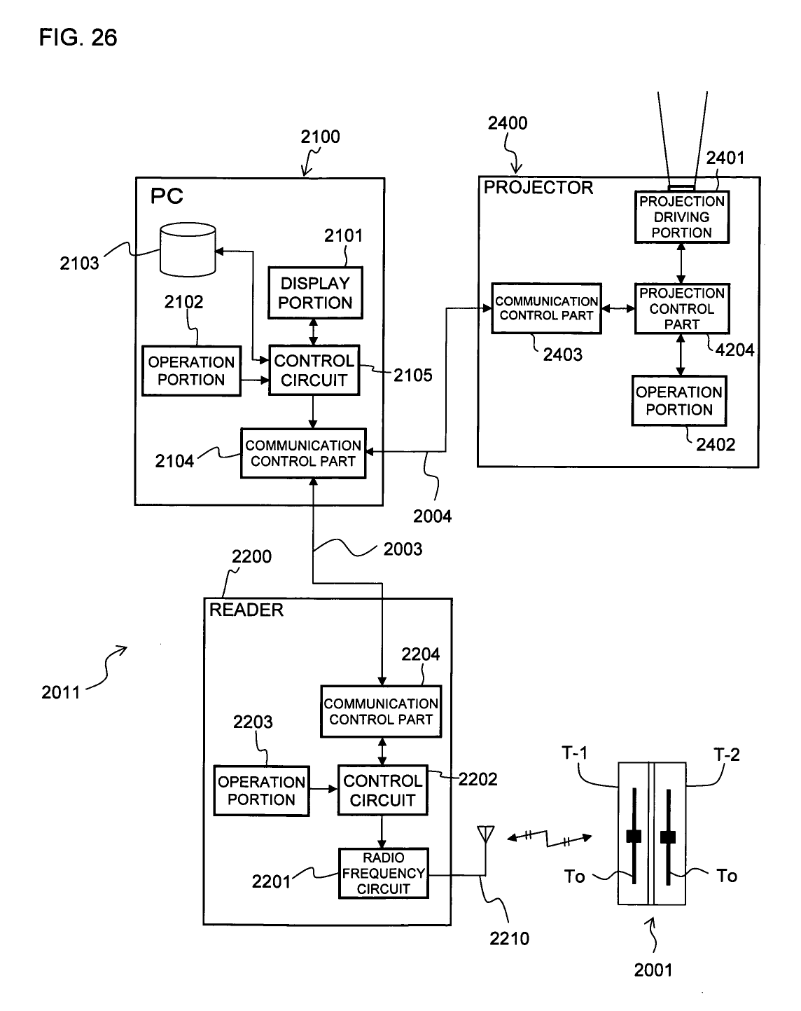

FIG. 26 is a functional block diagram illustrating detailed functions of the PC 2100, the reader 2200, and the projector 2400 constituting the RFID tag operation system 2011. In FIG. 26, the reader 2200 has the antenna 2210 that carries out signal transmission/receiving via radio communication with the antenna 151 of the RFID circuit element To in the RFID label T-1 or RFID label T-2 provided at the operation tag 2001, the radio frequency circuit 2201 that makes an access (reading in this example) to the IC circuit part 150 of the RFID circuit element To via the antenna 2210 and processes the signal read out of the RFID circuit element To, the control circuit 2202 that includes a function to process the signal read out of the IC circuit part 150 of the RFID circuit element To via the radio frequency circuit 2201 so as to read out information and to create access information to make an access to the IC circuit part 150 of the RFID circuit element To and controls an operation of the entire reader 2200, the operation portion 2203 provided with an appropriate button, key and the like that can be operated by the operator, and the communication control part 2204 that carries out control of communication with the PC 2100 via the connecting device 2003.

On the other hand, the projector 2400 has a projection driving portion 2401 that projects a matter to be projected (image data and the like, for example) to a target of projection (screen and the like, for example), an operation portion 2402 capable of various operations by the operator, a communication control part 2403 that carries out control of transmission/receiving of communication data/various signals with the PC 2100, and a projection control part 2404 connected to the projection driving portion 2401, the operation portion 2402, and the communication control part 2403 and carrying out operation control of the entire projector 2400.

The projection control part 2404 is provided with a CPU, a RAM, a ROM and the like, not shown, for example, and carries out predetermined calculation processing by inputting a signal from the operation portion 2402, the communication control part 2403 and outputs a projection control signal and the like to the projection driving portion 2401.

The projection by the projector 2400 is carried out in such a manner that the matter to be projected such as image data and the like is read out of the storage device 2103 by the control circuit 2105 of the PC 2100, an appropriate application is started and the read-out image data is opened, and the image data is outputted to the projection control part 2404 of the projector 2400 via the communication control part 2104 and the connecting device 2004. At this time, the image data being projected may be displayed on the display portion 2101 of the PC 2100.

In such configuration, in order to advance the projected image (constituted by a plurality of slides) projected by the projector 2400 to the subsequent slide image, the front face of the operation tag 2001 is brought close to the side of the reader 2200 (the back face on which “advance” is printed is opposed to the operator side). As a result, the operation command information stored in the RFID circuit element To of the RFID label T-1 attached to the front face of the operation tag 2001 is acquired from the reader 2200 to the side of the PC 2100, and on the basis of the operation command acquired as above by the control circuit 2105 of the PC 2100, the subsequent slide is opened, and the image data of the slide is outputted to the projector 2400. As a result, the subsequent slide is projected by the projector 2400.

On the other hand, in order to return the projection image being projected by the projector 2400 to the previous slide image, the back face of the operation tag 2001 is brought close to the side of the reader 2200 (the front face on which the “return” is printed is opposed to the operator side). As a result, the operation command information stored in the RFID circuit element To of the RFID label T-2 attached to the back face of the operation tag 2001 is acquired from the reader 2200 to the side of the PC 2100, and on the basis of the operation command acquired as above by the control circuit 2105 of the PC 2100, the previous slide is opened and the image data of the slide is outputted to the projector 2400. As a result, the previous slide is projected by the projector 2400.

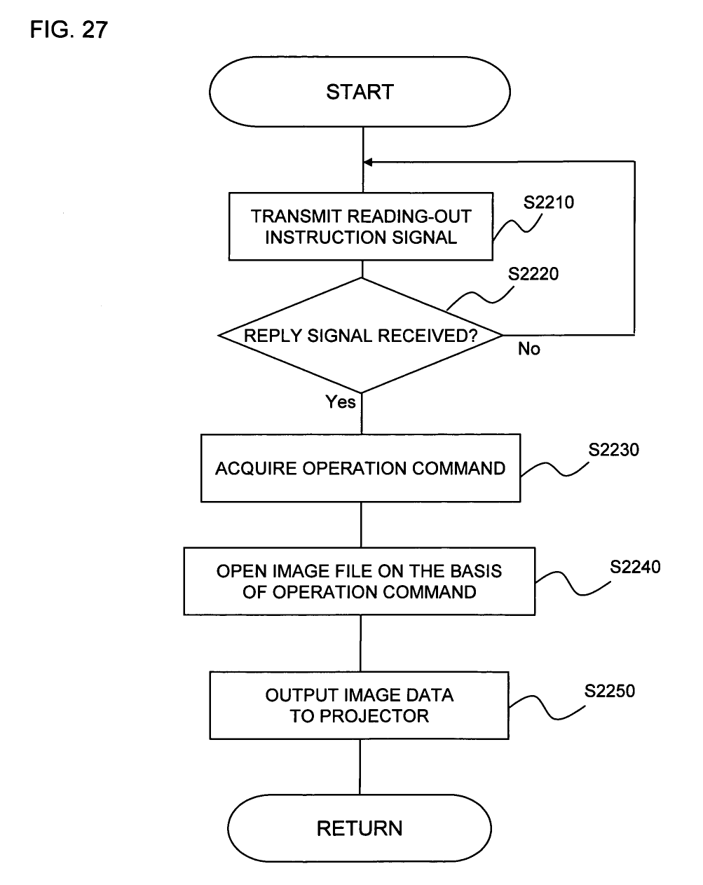

FIG. 27 is a flowchart illustrating a control procedure executed by the control circuit 2105 of the PC 2100 at reading out of the RFID tag information of the operation tag 2001. The control circuit 2105 repeats this flow all the time while the image data is being projected by the projector 2400, that is, an appropriate application is started so as to open the image data constituted by a plurality of slides and the image data is outputted to the projection control part 2404 of the projector 2400 via the communication control part 2104 and the connecting device 2004.

First, at Step S2210, to the control circuit 2202 of the reader 2200 via the communication control part 2104 and the connecting device 2003, a tag reading-out instruction signal to read out the RFID tag information of the operation tag 2001 is transmitted.

At the subsequent Step S2220, the reader 2200 having received the tag reading-out instruction signal transmits a signal to read out stored information to the RFID circuit element To of the RFID label T-1 or RFID label T-2 of the operation tag 2001, and it is determined if a reply signal transmitted (replied) from the RFID circuit element To in response to that has been received from the reader 2200 via the connecting device 2003 or not. If the reply signal has not been received from the reader 2200, the determination is not satisfied, and this Step is repeated. If the reply signal has been received, the determination is satisfied, and the routine goes to the subsequent Step S2230.

At Step S2230, from the reply signal received from the reader 2200, information corresponding to the operation command is read out and acquired. The read-out information is temporarily stored in an appropriate storage device (memory provided at the control circuit 2105 and the like, for example).

Subsequently, at Step S2240, on the basis of the operation command acquired at Step S2230, a corresponding slide (subsequent slide or previous slide) is read out from the storage device 2103 and opened.

At the subsequent Step S2250, the image data of the slide opened at step S2240 is outputted to the projector 2400 via the communication control part 2104 and the connecting device 2004. As a result, at the projector 2400, the slide is projected. And this flow is finished.

In the above, the control procedure at Step S2110 executed by the control circuit 2302 of the apparatus 2300 for producing a RFID label corresponds to an operation command input portion that inputs the operation command described in each claim and also corresponds to a print information input portion that inputs the print information corresponding to the operation command. Also, Step S2120 to Step S2170 executed by the control circuit 2302 correspond to a control portion (that is, constituting a part of the operation instruction processing portion) that controls in coordination the feeding device for tag carrier body and the writing device so that the plurality of RFID labels corresponding to each of the plurality of operation commands are created in lump sum, and Step S2120 and Step S2150 also correspond to a first print control portion that controls the printing device.

In the apparatus 2300 for producing a RFID label of the present embodiment configured as above, the tag tape 2303 on which the RFID circuit element To is arranged is fed by the feeding device 2309, information corresponding to the operation command created by the radio frequency circuit 2301 is written in the IC circuit part 150 of the RFID circuit element To via the antenna 2306, and the tag label body TT made of a plurality of RFID labels is produced.

At this time, in the IC circuit parts 150 of the plurality of RFID labels, information corresponding to the operation commands different from each other is written, respectively. As a result, by having the plurality of RFID labels correspond to the plurality of operations executed in the single equipment (projector in this example) to be operated, respectively, the tag label body TT made of the plurality of RFID labels for equipment operation can be produced easily in lump sum at the same time.

Also, particularly in the present embodiment, the tag label body TT is produced by writing the information corresponding to the operation command inputted by the operator using the operation portion 2102 of the PC 2100 in the IC circuit part 150 of the RFID circuit element To. As a result, the tag label body TT in which the information corresponding to the operation command desired by the operator can be produced.

Also, particularly in the present embodiment, the layers other than the separation sheet 2303a are half-cut by the half-cutter 2311 so as to form the half-cut line HC. As a result, in the RFID labels T-1, T-2 constituting the tag label body TT produced by the apparatus 2300 for producing a RFID label, each of the RFID labels T-1, T-2 can be easily peeled off the separation sheet 2303a, respectively, using the half-cutline HC as shown in the above-mentioned FIG. 22A.

Also, particularly in the present invention, the command print corresponding to the operation command is applied by the print head 2305 on the print regions S1, S2 corresponding to the RFID circuit element To in the tag tape 2303. As a result, the RFID labels T-1, T-2 with print on which the print corresponding to the operation command stored in the RFID circuit element To is applied can be realized. As a result, the operator can use the operation command function of the RFID labels T-1, T-2 produced in a lump sum, respectively, while visually checking the print corresponding to the operation command, by which convenience can be improved.

Also, particularly in the present embodiment, on the print region S1 provided at the RFID label T-1 attached to the front side of the operation tag 2001, the command print corresponding to the operation command stored in the IC circuit part 150 of the RFID label T-2 attached to the back side of the operation tag 2001 is applied, and on the print region S2 provided at the RFID label T-2 attached to the back side of the operation tag 2001, the command print corresponding to the operation command stored in the IC circuit part 150 of the RFID label T-1 attached to the front side of the operation tag 2001 is applied. As a result, the operator can carry out the operation while visually checking the print corresponding to the operation command to be executed by the operator.

The present embodiment is not limited to the above mode, either, but capable of various variations in a range not departing from its gist and technical idea. The variations will be described below in order.

(2-1) When the Fact that Tags Constitute a Single Set is Printed on a Margin Portion:

In the above second embodiment, only the printing relating to the operation command is made on the RFID labels T-1, T-2 constituting the tag label body TT, but not limited to that. That is, the fact that the plurality of RFID labels are RFID labels relating to each other and produced in a lump sum (in other words, they are RFID labels used for producing the same operation tag) may be printed. In the variation described below, it is configured such that a margin portion is created by half-cutting in each RFID label and by making the above print on a margin portion, the operation tag 2001 can be made only by the label body on which printing relating to the operation command is made.

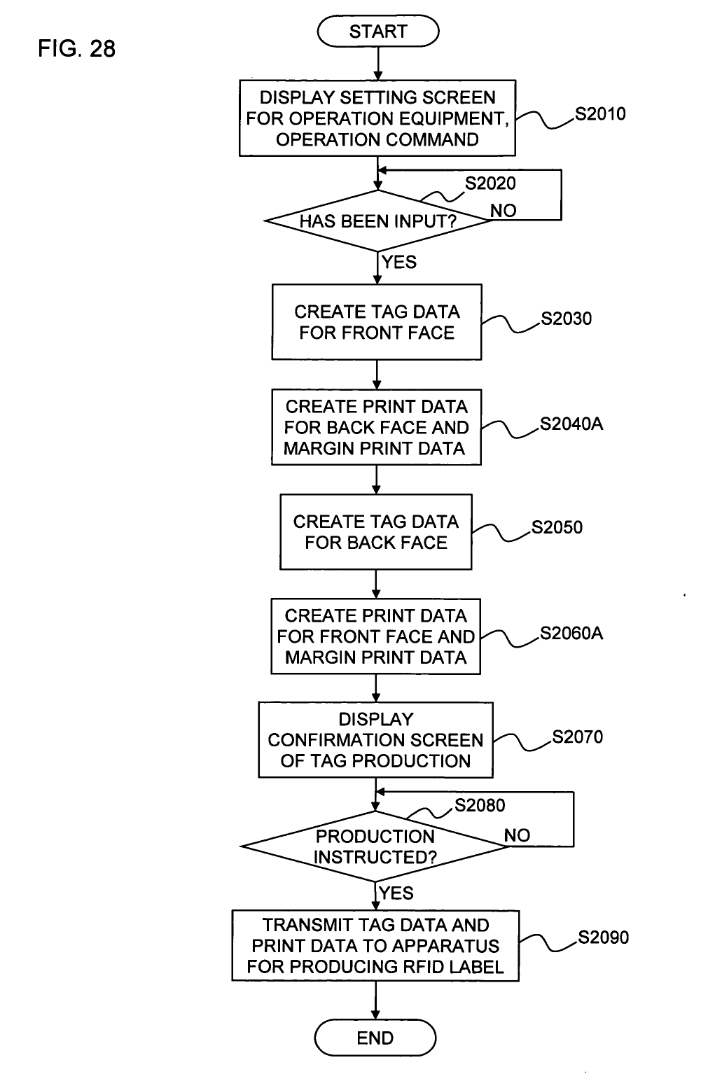

FIG. 28 is a flowchart illustrating a control procedure executed by the control circuit 2105 of the PC 2100 in this variation and corresponds to the above-mentioned FIG. 18. The same reference numerals are given to the same procedure as in FIG. 18 and the description will be omitted.

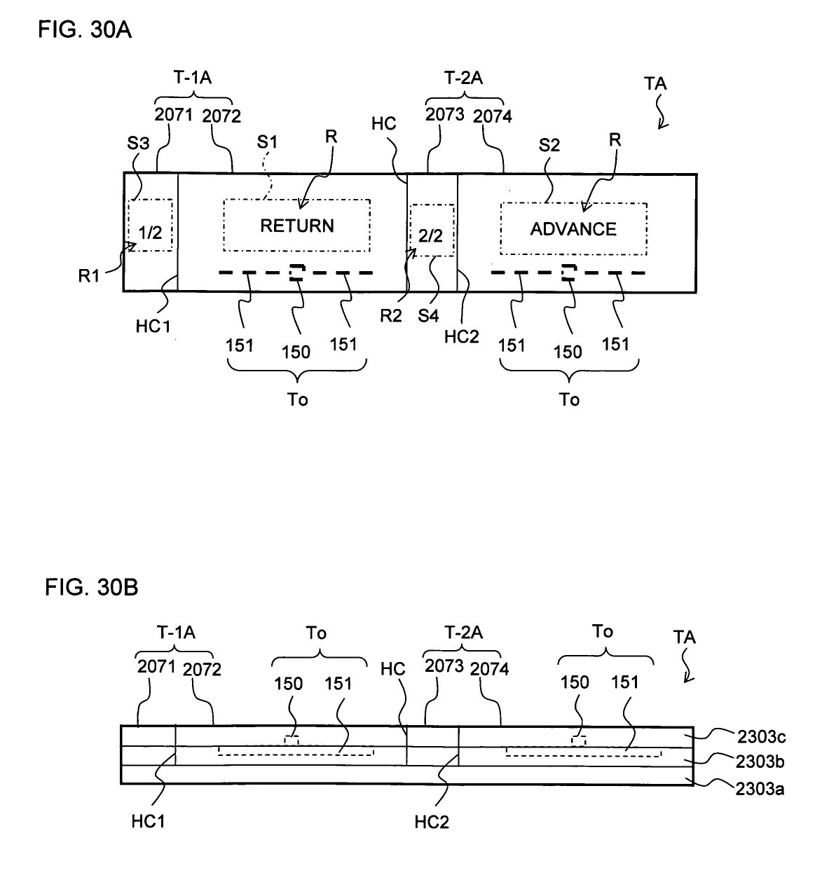

In FIG. 28, Step S2010 to Step S2030 are the same as the above-mentioned FIG. 18. And at the subsequent Step S2040A, on the basis of the tag data for front face created at Step S2030, the print data to be printed on the RFID label T attached to the back face of the operation tag 2001 is created, and the margin print data indicating that the RFID labels T-1A, T-2A constituting the tag label body TA in this variation are produced in a lump sum and related to each other (“1/2” indicating that the RFID label T-1A is the first of the two RFID labels constituting the tag label body TA in this example. See FIG. 30, which will be described later) is created.

The subsequent Step S2050 is the same as in the above-mentioned FIG. 18, and the tag data for back face is created. And at the subsequent Step S2060A, similarly to Step S2040A, on the basis of the tag data for back face created at Step S2050, the print data to be printed on the RFID label T attached to the front face of the operation tag 2001 is created, and the margin print data indicating that the RFID labels T-1A, T-2A constituting the tag label body TA in this variation are produced in a lump sum and related to each other (“2/2” indicating that the RFID label T-2A is the second of the two RFID labels constituting the tag label body TA in this example. See FIG. 30, which will be described later) is created. Since the subsequent Step S2070 to Step S2090 are the same as in the above-mentioned FIG. 18, the description will be omitted.

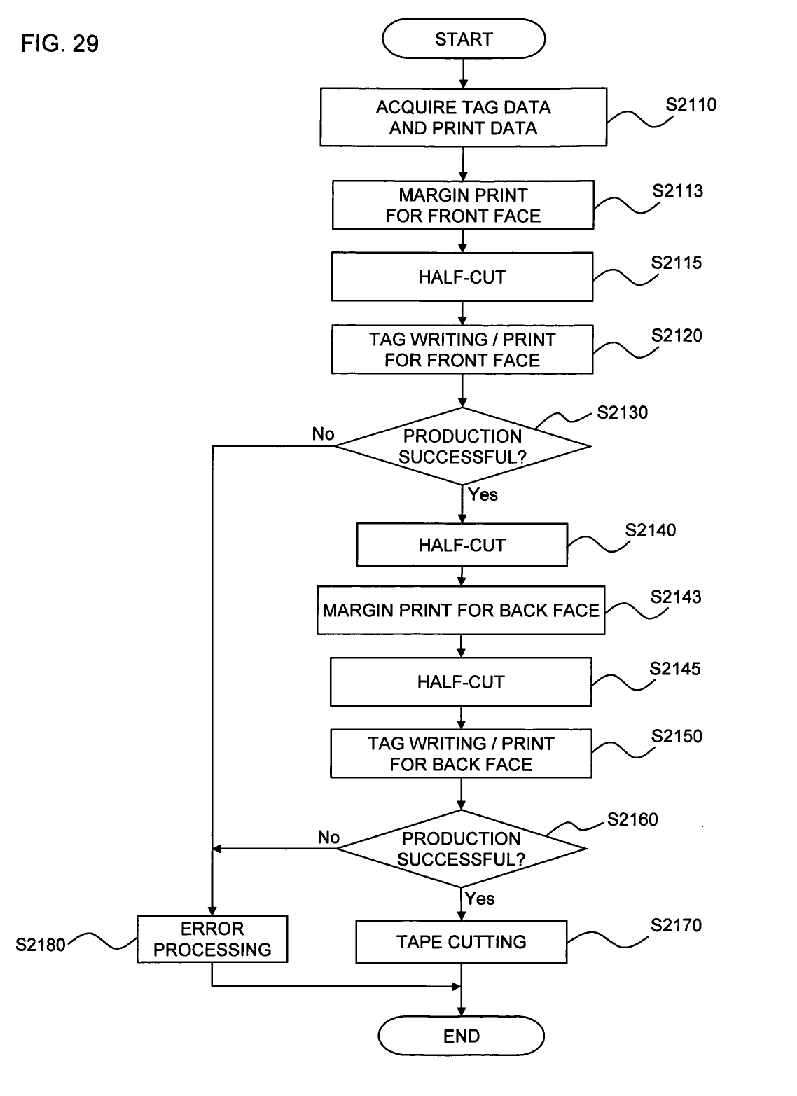

FIG. 29 is a flowchart illustrating a control procedure executed by the control circuit 2302 of the apparatus 2300 for producing a RFID label of this variation and corresponds to the above-mentioned FIG. 19. The same reference numerals are given to the same procedure as in FIG. 19 and the description will be omitted.

In FIG. 29, Step S2110 is the same as in the above-mentioned FIG. 19, and on the basis of the received data from the PC 2100, the tag data and print data (including margin print data), respectively, corresponding to the front face/back face of the operation tag 2001 are acquired.

At the subsequent Step S2113, on the basis of the margin print data acquired at Step S2110 (character data of “1/2” in this example), print is applied by the print head 2305 on a print region S3 corresponding to the front face of the operation tag 2001 (second print region. See FIG. 30, which will be described later).

At the subsequent Step S2115, in the RFID label T-1A constituting the tag label body TA, half-cut to cut the layers other than the separation sheet 2303a in the tag tape 2303 (the adhesive layer 2303b and the base film 2303c) in the width direction is carried out in order to separate a label main body 2071 and a margin portion 2072 from each other (See FIG. 30, which will be described later).

The subsequent Step S2120 to Step S2140 are the same as the above-mentioned FIG. 19, and to the RFID circuit element To corresponding to the RFID label T-1A, tag data is written and the print is applied by the print head 2305 on the print region S1, and if the tag label production is successful, the half-cut to separate the RFID labels T-1A, T-2A from each other is carried out.

At the subsequent Step S2143, on the basis of the margin print data acquired at Step S2110 (character data of “2/2” in this example), print is applied by the print head 2305 on a print region S4 corresponding to the back face of the operation tag 2001 (second print region. See FIG. 30, which will be described later).

At the subsequent Step S2145, in the RFID label T-2A constituting the tag label body TA, half-cut to cut the layers other than the separation sheet 2303a in the tag tape 2303 (the adhesive layer 2303b and the base film 2303c) in the width direction is carried out in order to separate a label main body 2073 and a margin portion 2074 from each other (See FIG. 30, which will be described later).

Since the subsequent Step S2150 to Step S2180 are the same as the above-mentioned FIG. 19, the description will be omitted.

FIGS. 30A and 30B are views illustrating an example of an appearance of the tag label body TA produced as above, in which FIG. 30A is a top view and FIG. 30B is its side view seen from the lower direction in FIG. 30A and corresponds to the above-mentioned FIG. 20. The same reference numerals are given to the portions similar to those in FIG. 20 and the description will be omitted.

In FIGS. 30A and 30B, the tag label body TA has two RFID labels of the RFID label T-1A corresponding to the front face of the operation tag 2001 and the RFID label T-2A corresponding to the back face. And in each of the RFID labels T-1, T-2, the prints R corresponding to the operation commands (characters of “return”, “advance” in this example) are printed in the print regions S1, S2 of the label main bodies 2072, 2074, respectively, and the prints R1, R2 indicating that the RFID labels T-1A, T-2A are related RFID labels produced in a lump sum (print identifier. “1/2”, “2/2” in this example) are printed on the print regions S3, S4 of the margin portions 2071, 2073.

Between the RFID label T-1A and the RFID label T-2A, the above-mentioned half-cut line HC (first half-cut portion) is formed, by which, in the RFID label body TA, the RFID labels T-1A, T-2A are configured to be connected at the position of the half-cut line HC through the separation sheet 2303a. Moreover, in each of the RFID labels T-1A, T-2A, half-cut lines HC1, HC2 (second half-cut portion) are formed, respectively, by which each of the RFID labels T-1A, T-2A is configured such that the label main bodies 2072, 2074 and the margin portions 2071, 2073 are connected at the half-cut lines HC1, HC2 through the separation sheet 2303a.

In the above, the control procedure of Step S2113 and Step S2143 executed by the control circuit 2302 correspond to a second print control portion configured to control the printing device so that the print identifier indicating that they are related RFID labels produced in a lump sum is printed on the second print regions as described in each claim.

According to the variation with the above configuration, since the prints R1, R2 indicating that they are related RFID labels produced in a lump sum are printed on the print regions S3, S4 provided at each of the RFID labels T-1A, T-2A produced in a lump sum, it can be clearly indicated that the RFID labels T-1A, T-2A are operation tags corresponding to the same equipment to be operated (projector). Also, as a result, when the operation tag 2001 is to be produced by attaching the RFID labels T-1A, T-2A to the base material 2250, attachment of a different RFID label can be avoided.

Also, according to this variation, each of the RFID labels T-1A, T-2A are configured such that the label main bodies 2072, 2074 are connected to the margin portions 2071, 2073 at the positions of the half-cut lines HC1, HC2 through the separation sheet 2303a. As a result, by using the half-cut lines HC1, HC2, only the label main bodies 2072, 2074 excluding the margin portions 2071, 2073 can be peeled off the separation sheet 2303a. As a result, a labor to cut off the unnecessary margin portions 2071, 2073 can be saved, and only the necessary portions, which are the label main bodies 2072, 2074, can be used.

In the above variation, the prints R1, R2 expressing the numbers “1/2”, “2/2” are used to indicate that the RFID labels T-1A, T-2A are related RFID labels produced in a lump sum, but not limited to that, but characters such as “front” “back” may be printed, for example, or a pattern may be printed.

(2-2) When Operation Tag Having Three or More RFID Labels is to be Produced:

In the above second embodiment, a case where the tag label body TT constituted by two RFID labels is produced and a card-like operation tag to which these two RFID labels are attached to the front and back is produced is shown as an example, but not limited to that. That is, a tag label body constituted by three or more RFID labels may be produced and a cubic operation tag may be produced using them.

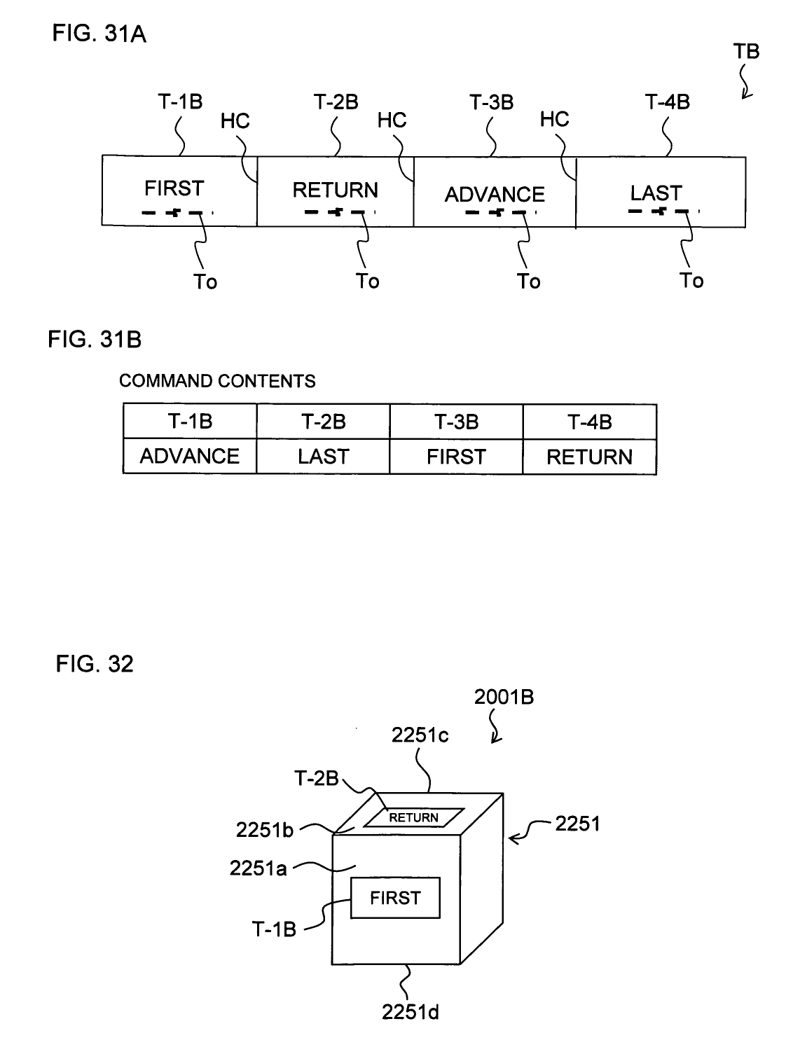

FIG. 31A is a top view illustrating an example of an appearance of a tag label body TB formed by completing information writing/print in the RFID circuit elements To corresponding to a front face/upper face/back face/lower face of an operation tag 2001B (RFID tag structural body. See FIG. 32, which will be described later), respectively, and cutting the tag tape 2303 by the procedure similar to that in the above-mentioned second embodiment, and FIG. 31B is a diagram illustrating contents of the operation command stored in each RFID circuit element To constituting the tag label body TB.

In FIG. 31A, the tag label body TB has four RFID labels of a RFID label T-1B corresponding to the front face of the operation tag 2001B, a RFID label T-2B corresponding to the upper face, a RFID label T-3B corresponding to the back face, and a RFID label T-4B corresponding to the lower face. And in each of the RFID labels T-1B to T-4B, the RFID circuit element To in which information corresponding to the operation command, which will be described later, has been written is arranged on one side in the width direction in a biased manner (lower side in FIG. 31), respectively, and prints R (characters of “first”, “return”, “advance”, and “last” in this example) are printed by the print head 2305 on print regions on the surface of the base film 2303c, respectively.

Between the RFID labels T-1B and T-2B, between the RFID labels T-2B and T-3B, and between the RFID labels T-3B and T-4B, the half-cut line HC is formed by cutting the layers other than the separation sheet 2303a (the base film 2303c and the adhesive layer 2303b) by the above-mentioned half-cutter 2311, by which the tag label body TB is configured such that the RFID labels T-1B, T-2B, T-3B, T-4B are connected at the position of the half-cut line HC through the separation sheet 2303a.

As shown in FIG. 31B, in each RFID circuit element To of the RFID labels T-1B, T-2B, T-3B, T-4B constituting the tag label body TB, the operation commands of “advance”, “last”, “first”, and “return” are stored, respectively. The “advance” command is the same as in the above-mentioned second embodiment and it is an operation command to move the projection image constituted by a plurality of slides to the subsequent slide in a projector to be operated, and the “return” command is also an operation command to move to the previous slide similarly. Also, the above “last” command is an operation command to move the projection image constituted by the plurality of slides to the last slide, while the above “first” command is an operation command to move the projection image constituted by the plurality of slides to the first slide.

And as shown in FIGS. 31A and 31B, these operation commands are written in the RFID circuit element To of each of the RFID labels T-1B to T-4B so that when the RFID labels T-1B, T-2B, T-3B, T-4B constituting the tag label body TB is attached to the base material 2251 and the operation tag 2001B (See FIG. 32, which will be described later) is formed, the print contents and stored contents match each other on the opposite face (front and back faces, upper and lower faces).

FIG. 32 is a perspective view illustrating an example of an entire outline structure of the operation tag 2001B produced by attaching the RFID labels T-1B, T-2B, T-3B, T-4B to the base material 2251.

In FIG. 32, the operation tag 2001B is formed substantially in a cubic state and is constituted by the substantially cubic-state base material 2251, the RFID label T-1B attached to a front face 2251a of the base material 2251 and on which the characters of “first” are printed, the RFID label T-2B attached to an upper face 2251b of the base material 2251 and on which the characters of “return” are printed, the RFID label T-3B attached to a rear face 2251c of the base material 2251 and on which the characters of “advance” are printed, and the RFID label T-4B attached to a lower face 251d of the base material 2251 and on which the characters of “return” are printed. Among the RFID labels T-1B to T-4B, only the RFID labels T-1B, T-2B attached to the front face 2251a and the upper face 2251b are shown in FIG. 32.

According to the variation with the above configuration, the operator can carry out four operations to the projector using the operation tag 2001B, which enables a variety of operations to the operation target.

Also, according to the variation, on the RFID label T-1B to be attached to the front side of the operation tag 2001B, the command print corresponding to the operation command stored in the RFID circuit element To of the RFID label T-3 to be attached to the rear side of the operation tag 2001B is applied, and similar prints are also applied to the other RFID labels T-2B, T-3B, T-4B. As a result, the operator can carry out the operation while visually checking the print corresponding to the operation command to be executed.

In the above variation, a case where the operation tag is constituted substantially in a cubic state is described as an example, but not limited to that, other operation tags in a variety of cubic shapes such as a polyhedron can be constituted. Also, in the above, the RFID label is attached only to four faces of the base material 2251 substantially in the cubic state, but the RFID label may be attached to the remaining two side faces. In this case, the print in the same mode as in a dice is applied on each RFID label, for example, and number information (number information printed on the opposite face) corresponding to each RFID circuit element is stored so that the produced operation tag can be used as an electronic dice, for example.

(2-3) When the Operation Target is Limited:

In the above second embodiment, the operation target by the operation tag is not particularly limited, but in order to prevent malfunction by the operation command to other equipment, the operation target may be limited so that a command is executed only for the operation target. A variation described below is configured such that it is determined if the target is an operation target or not and if not, the command can be transferred to equipment to be operated.

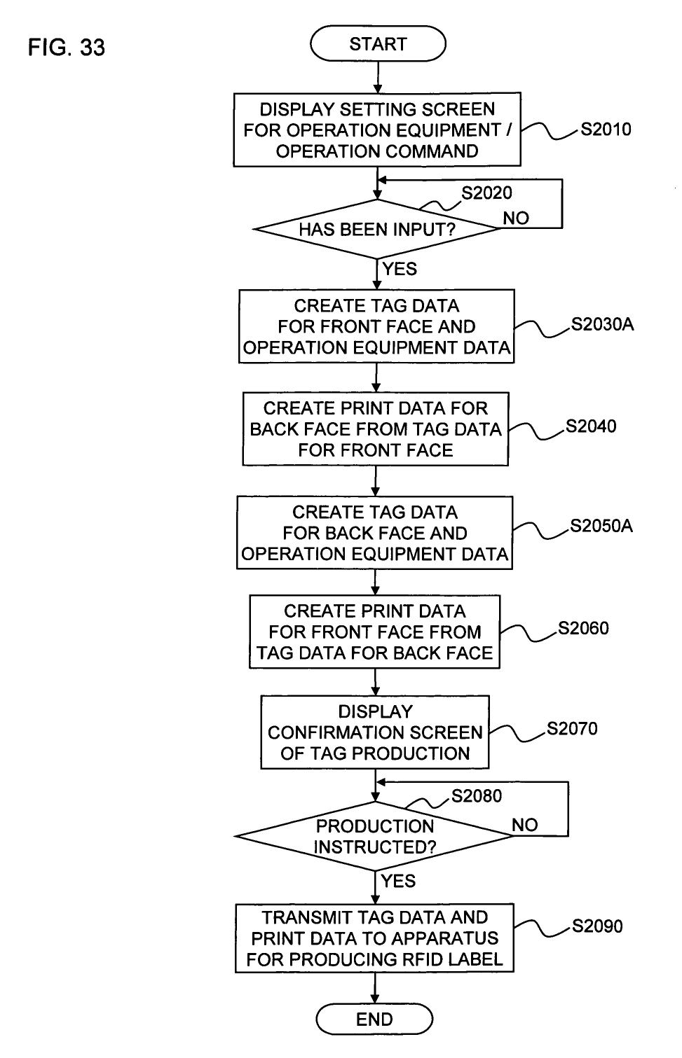

FIG. 33 is a flowchart illustrating a control procedure executed by the control circuit 2105 of a PC 2100A in this variation and corresponds to the above-mentioned FIG. 18. The same reference numerals are given to the same procedures as those in FIG. 18 and the description will be omitted.

In FIG. 33, Step S2010 to Step S2020 are the same as in the above-mentioned FIG. 18. And at the subsequent Step S2030A, on the basis of the information on equipment to be operated and the operation command information inputted at Step S2020, tag data for front face to be written in the RFID circuit element attached to the surface of the operation tag 2001 is created. In this tag data, in addition to the information corresponding to the operation command, information on equipment to be operated (operation target limitation information) limiting the operation target to carry out a predetermined operation by the operation command to the above-inputted equipment to be operated is included.

The subsequent Step S2040 is the same as in the above-mentioned FIG. 18, and on the basis of the command information in the tag data for front face, the print data to be printed on the RFID label T to be attached to the back face of the operation tag 2001 is created. And at the subsequent Step S2050A, similarly to Step S2030A, on the basis of the information on equipment to be operated and operation command information inputted at Step S2020, the tag data for back face to be written in the RFID circuit element To be attached to the back face of the operation tag 2001 is created. The tag data includes the information on equipment to be operated (operation target limitation information) in addition to the information corresponding to the operation command. Since the subsequent Step S2060 to Step S2090 are the same as in FIG. 18, the description will be omitted.

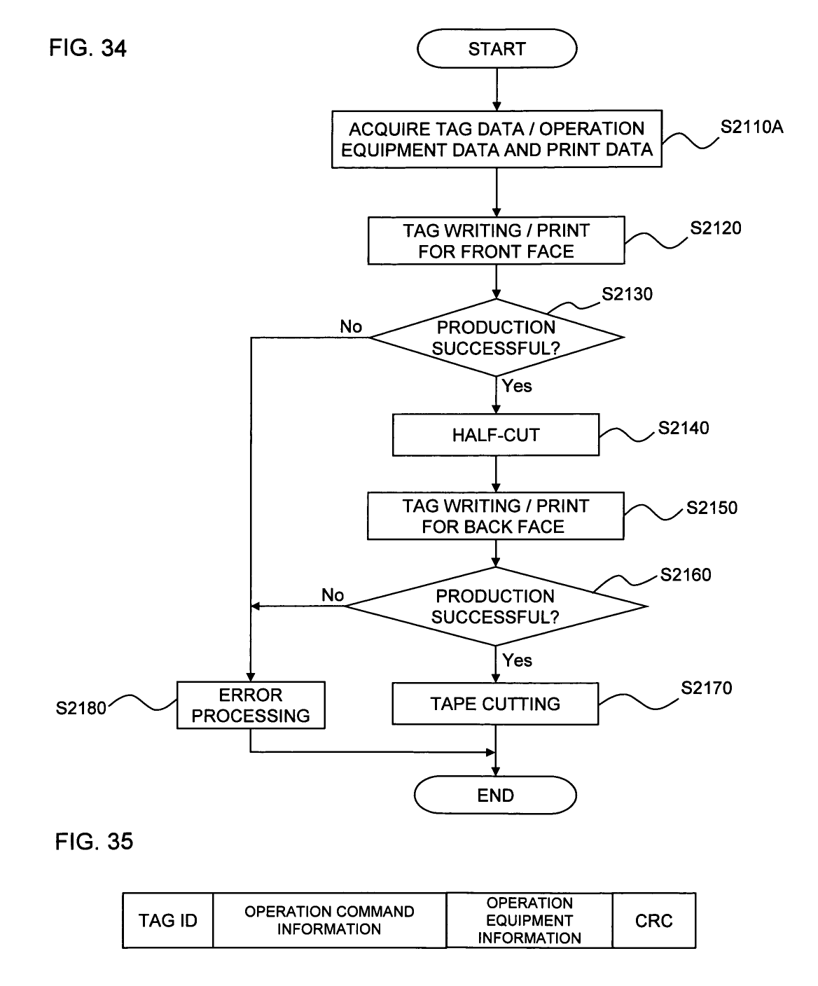

FIG. 34 is a flowchart illustrating a control procedure executed by the control circuit 2302 of the apparatus 2300 for producing a RFID label at production of the operation tag 2001 (tag label body) in this variation and corresponds to the above-mentioned FIG. 19. The same reference numerals are given to the same procedures as those in FIG. 19, and the description will be omitted.

In FIG. 34, at Step S2110A, on the basis of the received data from the PC 2100, the tag data and print data corresponding to the front face/back face of the operation tag 2001, respectively, are acquired. The tag data includes the information on equipment to be operated in addition to the information corresponding to the operation command.

After that, Step S2120 to Step S2180 are the same as the above-mentioned FIG. 19 and the tag data (including the information corresponding to the operation command and the information on equipment to be operated limiting the equipment to be operated) is written in the RFID circuit element To of each RFID label, the print is applied by the print head 2305 on the corresponding print region, and the tag label body TT is produced.

FIG. 35 is a diagram illustrating an example of data configuration of the memory part 155 in the IC circuit part 150 of the RFID circuit element To in the RFID labels T-1, T-2 constituting the tag label body TT produced as above.

As shown in FIG. 35, in this variation, the data stored in the memory part 155 of the IC circuit part 150 in the RFID circuit element To is constituted by the tag ID, which is identification information specific to the RFID circuit element To, the operation equipment information limiting the equipment to be operated (projector 2400, here), information corresponding to the operation command to have the equipment to be operated carry out a predetermined operation, and an error detection code CRC (Cyclic Redundancy Check) indicating validity of the data.

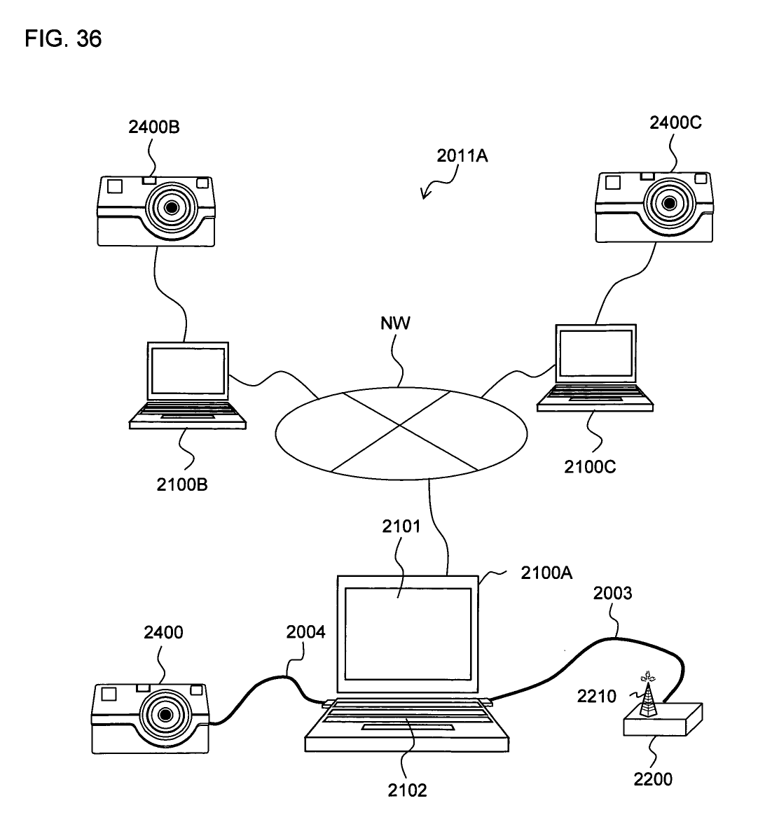

FIG. 36 is a system block diagram illustrating an entire RFID tag operation system (operation processing apparatus) including the reader 2200 of the variation.

A RFID tag operation system 2011A shown in FIG. 36 is provided with, in addition to the reader 2200 (RFID tag information reading device, operation instruction processing device), the PC 2100A, and the projector 2400 as in the above-mentioned second embodiment, a PC 2100B and a projector 2400B connected to the PC 2100A via wired or radio communication line NW and a PC 2100C and a projector 2400C.

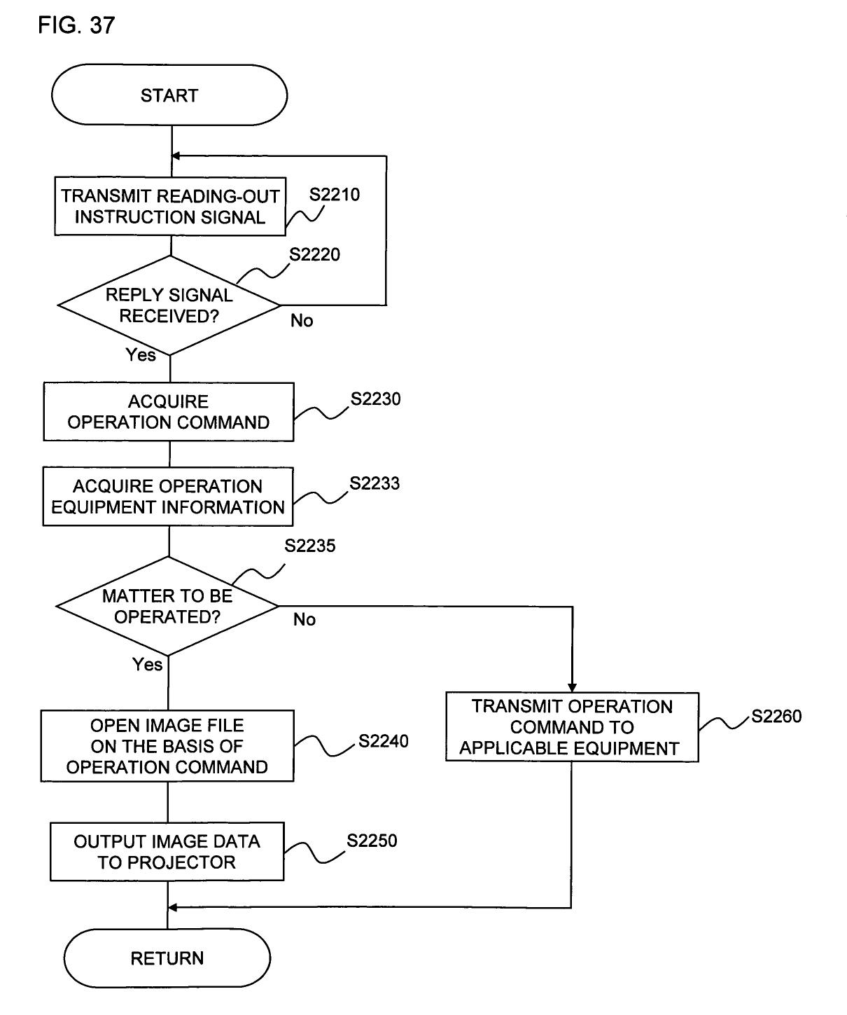

FIG. 37 is a flowchart illustrating a control procedure executed by the control circuit 2105 of the PC 2100A when the RFID tag information of the operation tag 2001 is read out and corresponds to the above-mentioned FIG. 27. The same reference numerals are given to the same procedures as those in FIG. 27 and the description will be omitted.

In FIG. 37, Step S2210 to Step S2230 are the same as the above-mentioned FIG. 27, and a tag reading-out instruction signal is transmitted to the reader 2200, and it is determined if a reply signal has been received from the RFID circuit element To or not in response to a signal for reading out information transmitted by the reader 2200. If the reply signal has been received, information corresponding to the operation command is acquired from the reply signal. And the routine goes to the subsequent Step S2233.

At Step S2233, from the reply signal received from the reader 2200, information on equipment to be operated limiting the operation target is read out and acquired. The read-out information is temporarily stored in an appropriate storage device (a memory and the like provided at the control circuit 2105, for example).

At the subsequent Step S2235, on the basis of the information on equipment to be operated acquired at Step S2223, it is determined if the operation target is the projector 2400 or not (in other words, if it is possible to execute “advance” “return” processing of the projection slide of the projector 2400 or not). If the operation target is the projector 2400, the slide is moved on the basis of the operation command acquired at the subsequent Step S2240 and Step S2250, and the image data is outputted to the projector 2400. As a result, at the projector 2400, an operation corresponding to the operation command is carried out.

On the other hand, at step S2235, if the operation target is not the projector 2400, the determination is not satisfied and the routine goes to Step S2260. At Step S2260, on the basis of the information on equipment to be operated, the operation command information is transmitted to corresponding equipment. For example, if the operation target in this variation is the projector 2400B (or the projector 2400C. Hereinafter, the correspondence applies similarly), the operation command information is transmitted to the projector 2400B and the projector 2400C through the communication line NW and the PC 2100B (or PC2100C). And this flow is finished.

In the above, the procedure at Step S2110A executed by the control circuit 2302 of the apparatus 2300 for producing a RFID label corresponds to an operation target limitation information input portion that inputs the operation target limitation information limiting the operation target to carry out a predetermined operation by the operation command described in each claim.

Also, the procedure at Step S2235 executed by the control circuit 2105 of the PC 2100A corresponds to a command determining portion that makes determination on the operation target of the operation command read out by the RFID tag information reading device, and Step S2240 and Step S2250 correspond to a command executing portion that carries out processing corresponding to the operation command according to a determination result of the command determining portion (these Steps also constitute the operation instruction processing portion). Also, Step S2260 corresponds to a command transfer portion that transfers the operation command to another device according to the determination result of the command determining portion.

According to the above variation, when an operation command having the operation target as the projector 2400B (or the projector 2400C) is read out by the reader 2200 and inputted to the PC 2100A, execution of the operation command at the projector 2400 can be prevented. Therefore, malfunction by the operation command to other equipment can be prevented. As a result, operation reliability of the RFID tag operation system 2011A to have the operation target carry out a predetermined operation using the RFID tag information can be improved.

Moreover, according to this variation, an operation command with the operation target of the projector 2400B (or the projector 2400C) is read out by the reader 2200 and inputted to the PC 2100A, for example, the operation command information is transferred from the PC 2100A to the PC 2100B (or the PC 2100C) via the communication line NW. As a result, even if the operation command of a projector in a first meeting room as the operation target, for example, is outputted to a PC2 connected to a projector in a second meeting room, the operation command can be transferred from the PC2 to a PC1 connected to the projector in the first meeting room through an in-house network, for example, so that the PC1 can have the projector in the first meeting room carry out the desired operation, and the operation reliability of the RFID tag operation system 2011A can be further improved.

In the above, the determination on the operation target of the operation command is made by the PC 2100A (control circuit 2105), but not limited to that, the determining function may be carried out by the reader 2200 or the projector 2400.

(2-4) Other Operation Commands:

In the above, movement of the projection slides in a projector (“advance”, “return” and the like) has been described as an example of the operation command, but not limited to that. That is, a variety of operations such as power on/off operation in various equipment (including the projector, PC and the like), switching of the image file itself (not slides) being projected in the projector and the like, login/logout operation in the PC and the like, user switching operation, operator authority switching operation and the like, for example, can be written in the IC circuit part 150 of the RFID circuit element To as an operation command, and the RFID label for operation can be produced in a lump sum.

(2-5) When Awaited for a Predetermined Time Till Command Execution:

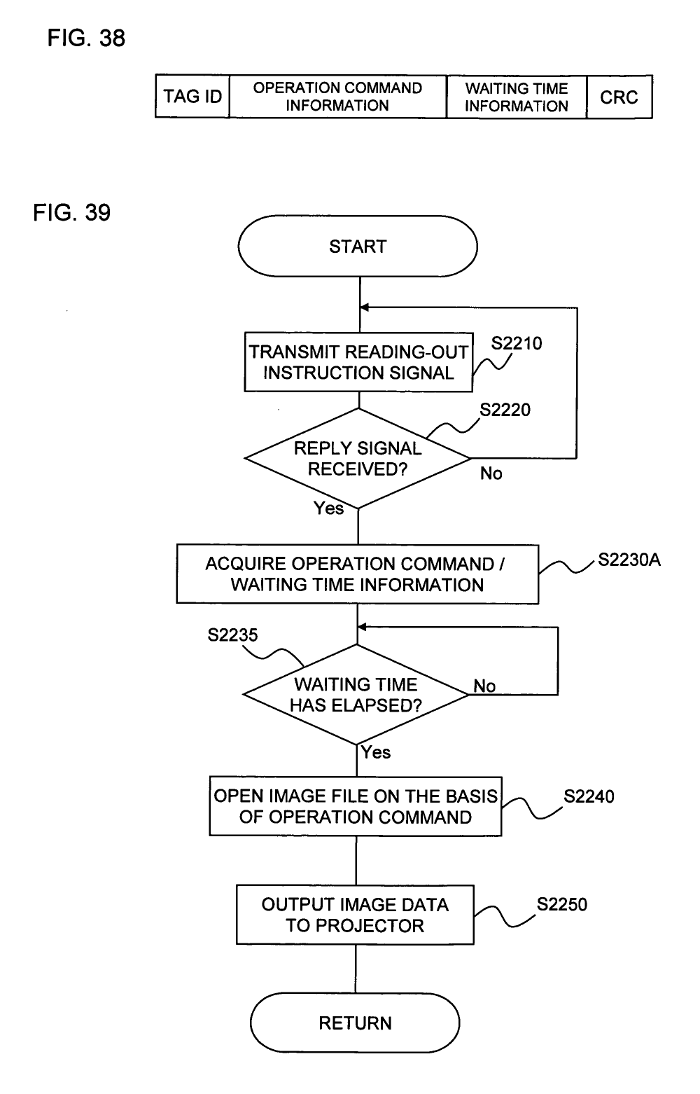

FIG. 38 is a diagram illustrating an example of data configuration of the memory part 155 of the IC circuit part 150 in the RFID circuit element To in the RFID label of this variation.

In the example shown in FIG. 38, the data stored in the memory part 155 of the IC circuit part 150 in the RFID circuit element To is constituted by a tag ID, which is identification information specific to the RFID circuit element To, information corresponding to the operation command to have the equipment to be operated (projector 2400, here) carry out a predetermined operation, waiting time information corresponding to a waiting time till the operation target executes the operation command, and an error detection code CRC (Cyclic Redundancy Check) indicating validity of the data.

FIG. 39 is a flowchart illustrating a control procedure executed by a control circuit 2105C (not shown) of the PC 2100 at reading of the RFID tag information of the operation tag 2001 in this variation and corresponds to the above-mentioned FIG. 27. The same reference numerals are given to the same procedures as in FIG. 27 and the description will be omitted. The waiting time information is written at Step S2120 or Step S2150 through the radio frequency circuit 2301 at the label production similarly to the above.

Step S2210 and Step S2220 are the same as in the above-mentioned FIG. 27, and a tag reading instruction signal for reading out the RFID tag information of the operation tag 2001 is transmitted to the control circuit 2202 of the reader 2200, the reader 2200 having received the tag reading instruction signal transmits a signal for reading the stored information to the RFID circuit element To in the RFID label T of the operation tag 2001, and it is determined if a reply signal transmitted (replied) from the RFID circuit element To in response to that has been received or not. If the reply signal has been received, the determination is satisfied, and the routine goes to Step S2230A.

At Step S2230A, from the reply signal received from the reader 2200, information corresponding to the operation command and waiting time information corresponding to the waiting time till the operation target executes the operation command are read out and acquired. The information read out at this time is temporarily stored in an appropriate storage device (memory provided at the control circuit 2105C and the like, for example).

At the subsequent Step S2235, after the operation command is acquired at Step S2230A, it is determined if time corresponding to the waiting time information acquired at that Step has elapsed or not. The Step is repeated till the waiting time has elapsed, and if elapsed, the determination is satisfied and the routine goes to the subsequent Step S2240.

Step S2240 and Step S2250 are the same as the above-mentioned FIG. 27, and on the basis of the operation command acquired at Step S2230, a corresponding slide (subsequent slide or previous slide) is read out from the storage device 2103 and opened. And the image data of the slide is outputted to the projector 2400 through the communication control part 2104 and the connecting device 2004. As a result, the slide is projected by the projector 2400. And this flow is finished.

According to the variation with the above configuration, when the projector 2400 is operated by the operator using the operation tag 2001, after the waiting time corresponding to the waiting time information stored in the RFID circuit element To has elapsed, the operation command is executed at the projector 2400. As a result, if a wrong operation command is instructed to the operation target such as when the operator erroneously operates the “return” though he/she wants to advance the slide and the like, correction can be made so that a right operation command is executed during the waiting time of the wrong operation command.

(2-6) Others:

In the above, the reader 2200 is provided separately from the projector 2400 as the operation target so that the processing according to the operation command is carried out by the PC 2100 according to the operation command read out by the reader 2200 and the projector is made to carry out a predetermined operation, but not limited to that. For example, the projector itself may have the reader function in configuration. In this case, when the operator brings the operation tag closer to the projector so that the operation command is read out, the operation command is transmitted from the projector to the PC, the processing according to the operation command is carried out by the PC, and the projector carries out the operation according to the operation command. Also, the projector itself may be configured to have a storage device that stores image data, application files and the like in addition to the reader function. In this case, the RFID tag operation system is constituted singularly by the projector.

Also, in the above, such a method was employed that the print is applied on a print-receiving tape layer provided at the tag tape (bonding is not carried out) but not limited to that, the present invention may be applied to a method in which that the print is applied on a cover film (a print-receiving tape to be bonded to the tag tape) separate from the tag tape 2303 provided with the RFID circuit element To and they are bonded. Moreover, the present invention is not limited to such a type that the RFID tag information is read out of or written in the IC circuit part 151 of the RFID circuit element To and the printing to identify the RFID circuit element To is carried out by the print head 2305. This printing does not necessarily have to be carried out but the present invention may be applied to such a type that only reading or writing of the RFID tag information is carried out.

Moreover, in the above, such a case has been described as an example that a roll is constituted by winding a tag tape around a reel member, the roll is arranged inside a tape with RFID tags holder portion 2310, and the tag tape is fed out, but not limited to that. For example, it may be so configured that a length flat-sheet state or strip-like tape or sheet in which at least one RFID circuit element To is arranged (including those formed by feeding the tape wound around the roll and then, cutting it to an appropriate length) is stacked in a predetermined container portion (flatly stacked in a tray-like container, for example) to be made into a cartridge, the cartridge is attached to a cartridge holder on the side of the apparatus 2300 for producing a RFID label the tape is transferred and fed from the container portion, on which printing and writing are carried out so as to produce a RFID label.

Moreover, it may be also configured that the length flat-sheet state or strip-like tape or sheet is transferred one by one by a predetermined feeder mechanism from outside the apparatus 2300 for producing a RFID label so as to be supplied into the apparatus 2300 for producing a RFID label. In this case, too, the same effect is acquired.

Other than those mentioned above, methods of the embodiments and each variation may be combined as appropriate for use.

Though not specifically exemplified, the present invention should be put into practice with various changes made in a range not departing from its gist.

What is claimed is:

1. An operation processing apparatus comprising:
a communication device configured to carry out information transmission/receiving with a RFID circuit element provided with an IC circuit part storing information and a tag antenna connected to the IC circuit part via radio communication; and
an operation instruction processing portion configured to carry out information transmission/receiving with a plurality of said RFID circuit elements via said communication device so as to execute acquisition related processing of operation instruction information to an operation target from said RFID circuit element or writing related processing of operation instruction information to an operation target to said RFID circuit element.

2. The operation processing apparatus according to claim 1, wherein:
said communication device is configured to carry out information transmission/receiving to said RFID circuit element incorporated in a tag medium via radio communication; and
said operation instruction processing portion includes:
an information acquisition portion configured to get search element information relating to corresponding said tag medium via said communication device, said search element information stored as said operation instruction information in said IC circuit part of said RFID circuit element; and
a logical expression creating portion configured to create a logical expression for search to execute search in a database as said operation target on the basis of said search element information gotten by said information acquisition portion and an arrangement state of said tag medium.

3. The operation processing apparatus according to claim 2, future comprising an arrangement detecting device configured to detect said arrangement state of said tag medium, wherein:
said logical expression creating portion creates said logical expression for search on the basis of arrangement state information of said tag medium detected by said arrangement detecting device and said search element information.

4. The operation processing apparatus according to claim 3, wherein:
said arrangement detecting device includes at least one of a front/back detecting device configured to detect which of the front or back face said tag medium has as its upper face or a separation/overlapping detecting device configured to detect whether the plurality of said tag mediums are separated or overlapping with each other.

5. The operation processing apparatus according to claim 2, further comprising a plurality of communication regions for communication with said RFID circuit element of said tag medium, wherein:
a plurality of said communicating devices are provided at each of said plurality of communication regions; and
said logical expression creating portion has a region-specific creating portion configured to calculate a region-specific logical expression in each of said communication regions.

6. The operation processing apparatus according to claim 5, further comprising a logical sum creating portion configured to calculate a logical sum of a plurality of said region-specific logical expressions calculated by a plurality of said region-specific creating portions.

7. The operation processing apparatus according to claim 2 wherein:
said information acquisition portion gets at least one information of text information, time information, location information, and color information, as said search element information.

8. The operation processing apparatus according to claim 1, wherein:
said communicating device is a first communicating device configured to carry out information transmission/receiving with a first RFID circuit element provided at the tag medium via radio communication, said first RFID circuit element having said IC circuit part and said tag antenna,
said operation processing apparatus further comprises an arrangement detecting device configured to detect an arrangement state of said tag medium; and wherein,
said operation instruction processing portion includes:
an information acquisition portion configured to get search element information relating to corresponding said tag medium via said first communicating device; said search element information stored as said operation instruction information in said IC circuit part of said first RFID circuit element;
a logical expression creating portion configured to create a logical expression for search on the basis of said search element information gotten by said information acquisition portion and arrangement state information of said tag medium detected by said arrangement detecting device; and
a search signal output portion configured to output a search signal for executing search using said logical expression for search created by said logical expression creating portion in a database as said operation target.

9. The operation processing apparatus according to claim 8, further comprising a detection control portion configured to control said arrangement detecting device so that detection of an arrangement state of said tag medium is repeated by a predetermined cycle, wherein:
when a new said arrangement state is detected by said arrangement detecting device, said logical expression creating portion creates new said logical expression for search in response to the detection.

10. The operation processing apparatus according to claim 8, further comprising a display signal output portion configured to output a display signal for display of a search result of said database by said search signal outputted from said search signal output portion.

11. The operation processing apparatus according to claim 8, further comprising:
a plurality of communication regions configured to communicate with said first RFID circuit element of said tag medium; and
a switching control device configured to carry out said radio communication by selectively switching a plurality of said first communicating device provided respectively at said plurality of communication regions.

12. The operation processing apparatus according to claim 8, wherein:
said first communicating device has a matrix coil antenna including coil elements arranged substantially in a matrix state in two directions orthogonal to each other.

13. The operation processing apparatus according to claim 8, further comprising:
a feeding device for tag feeding body configured to feed a tag feeding body in which a second RFID circuit element having an IC circuit part storing information and a tag antenna connected to the IC circuit part is provided;
a second communicating device configured to carry out information transmission/receiving with said second RFID circuit element via radio communication; and
a writing control portion configured to write said logical expression for search created by said logical expression creating portion to said IC circuit part of said second RFID circuit element via said second communicating device.

14. The operation processing apparatus according to claim 1, further comprising a feeding device for tag carrier body configured to feed a tag carrier body in which said RFID circuit element is arranged, wherein:
said operation instruction processing portion includes:
a writing device configured to create information corresponding to an operation command to have said operation target carry out a predetermined operation as said operation instruction information and write the information in said IC circuit part via said communicating device; and
a control portion configured to control in coordination said feeding device for tag carrier body and said writing device so that a plurality of RFID labels corresponding to a plurality of said operation commands respectively are produced in a lump sum.

15. The operation processing apparatus according to claim 14, further comprising a cutter configured to cut a tag tape as said tag carrier to a predetermined length, wherein:
said control portion controls in coordination said feeding device for tag carrier body, said writing device, and said cutter so that a plurality of RFID labels corresponding to a plurality of said operation commands respectively are produced in a lump sum.

16. The operation processing apparatus according to claim 14, further comprising an operation command input portion configured to input said operation command, wherein:
said writing device creates information corresponding to said operation command inputted at said operation command input portion.

17. The operation processing apparatus according to claim 16, wherein:
said feeding device for tag carrier body feeds said tag tape having a base layer to which said RFID circuit element is attached, a bonding adhesive layer configured to bond the base layer to an object to be affixed, and a separation material layer covering the bonding adhesive layer;
said operation processing apparatus further comprises a half-cut device configured to form a first half-cut portion by cutting layers other than said separation material layer in said tag tape is provided, and wherein,
each of said plurality of RFID labels produced in a lump sum is connected at the first half-cut portion formed by said half-cut device through said separation material layer.

18. The operation processing apparatus according to claim 15, further comprising a printing device configured to apply a command print corresponding to said operation command on a first print region provided at said tag tape or a print-receiving tape to be bonded to the tag tape.

19. The operation processing apparatus according to claim 18, further comprising a print information input portion configured to input print information corresponding to said operation command, wherein:
said printing device applies a command print corresponding to said print information inputted at said print information input portion.

20. The operation processing apparatus according to claim 19 wherein:
the number of said RFID labels produced in a lump sum is two; and
a first print control portion configured to control said printing device is provided so that said command print corresponding to said operation command stored in said IC circuit part of the other RFID label is carried out on a first print region of one of said two RFID labels.

21. The operation processing apparatus according to claim 18, further comprising a second print control portion configured to control said printing device so that a print identifier indicating a related RFID label produced in a lump sum is printed on a second print region provided at each of said plurality of RFID labels produced in a lump sum.

22. The operation processing apparatus according to claim 21, wherein:
Each of said plurality of RFID labels produced in a lump sum includes a label main body having said first print region and a margin portion having said second print region, said main body being bonded to an object to be affixed; and
said half-cut device forms a second half-cut portion in which said label main body and said margin portion are connected by said separation material layer.

23. The operation processing apparatus according claim 15, wherein:
said control portion controls in coordination said feeding device for tag carrier body, said writing device, and said cutter so that at least three said RFID labels constituting a RFID structural body standing by itself on an installation surface are produced in a lump sum.

24. The operation processing apparatus according to claim 14, wherein:
said writing device creates a command for at least one operation of power on/off operation, login/logout operation, user switching operation, and operator authority switching operation as said operation command and write the command in said IC circuit part.

25. The operation processing apparatus according to claim 14, wherein:
said writing device creates information corresponding to a waiting time till said operation target executes said operation command and write the information in said IC circuit part.

26. The operation processing apparatus according to claim 14, further comprising an operation target limitation information input portion configured to input operation target limitation information limiting an operation target to carry out a predetermined operation by said operation command, wherein:
said writing device creates information corresponding to the operation command to the limited operation target on the basis of the operation target limitation information inputted by said operation target limitation information input portion and writes the information in said IC circuit part via said communicating device.

27. The operation processing apparatus according to claim 1, wherein:
said operation instruction processing portion includes:
a RFID tag information reading device configured to read out information corresponding to an operation command stored in said IC circuit part of said RFID circuit element as said operation instruction information;
a command determining portion configured to make determination relating to an operation target of the operation command read out by said RFID tag information reading device; and
a command executing portion configured to execute processing corresponding to the operation command according to a determination result of said command determining portion, wherein:
said operation target is made to carry out a predetermined operation.

28. The operation processing apparatus according to claim 27, further comprising a command transfer portion configured to transfer said operation command to another apparatus according to a determination result of said command determining portion.
